(19) United States
(12) Patent Application Publication
(10) Pub. No.: US 2022/0279302 A1
(43) Pub. Date: Sep. 1, 2022

(54) Audio Object Renderer, Methods for determining loudspeaker gains and computer program using panned object loudspeaker gains and spread object loudspeaker gains

(71) Applicant: Fraunhofer-Gesellschaft zur Foerderung der angewandten Forschung e.V., Munich (DE)

(72) Inventors: Aleksandr KARAPETYAN, Erlangen (DE); Oliver WUEBBOLT, Erlangen (DE); Christian BORSS, Erlangen (DE); Philipp STADTER, Erlangen (DE)

(21) Appl. No.: 17/749,922

(22) Filed: May 20, 2022

Related U.S. Application Data
(63) Continuation of application No. PCT/EP2020/082982, filed on Nov. 20, 2020.

(51) Int. Cl. H04S 7/00; H04R 5/04; H04R 3/12

(52) U.S. Cl. CPC H04S 7/30; H04R 5/04; H04R 3/12; H04S 2400/11

(57) ABSTRACT

An audio object renderer for determining loudspeaker gains describing gains for an inclusion of one or more audio object signals into a plurality of loudspeaker signals on the basis of an object position information and an object feature information or a spread information is configured to obtain panned object loudspeaker gains using a point source panning of the audio object. The audio object renderer is configured to obtain spread object loudspeaker gains considering the object position information and the object feature information or spread information. The audio object renderer is configured to combine the panned object loudspeaker gains and the spread object loudspeaker gains in such a manner, that there is a contribution of the panned object loudspeaker gains, in order to obtain combined loudspeaker gains. Methods and computer programs are also described.

### CROSS-REFERENCE TO RELATED APPLICATIONS

This application is a continuation of copending International Application No. PCT/EP2020/082982, filed Nov. 20, 2020, which is incorporated herein by reference in its entirety, and additionally claims priority from International Application No. PCT/EP2019/081922, filed Nov. 20, 2019, which is also incorporated herein by reference in its entirety.

Embodiments according to the invention relate to an audio object renderer.

Further embodiments according to the invention relate to methods for determining loudspeaker gains.

Further embodiments according to the invention relate to computer programs.

Embodiments according to the invention are generally related to a panning for audio objects with extended source size.

### BACKGROUND OF THE INVENTION

In the following, some background of the invention will be described. However, it should be noted that features, functionalities and applications mentioned in the following can optionally also be used in combination with embodiments according to the present invention.

In the area of surround sound reproduction, the loudspeakers are usually placed at some specific positions in the room. The commonly used surround reproduction system “5.1” contains three loudspeakers in the frontal and two in the rear hemisphere. If a signal (e.g., mono audio signal) is meant to be reproduced within the space between two loudspeakers, the signal is distributed proportionally to these two neighboring loudspeakers. This procedure also works with 3D loudspeaker setups, which additionally have loudspeakers above and/or below the horizontal plane. A well-known panning algorithm is the so-called “vector based amplitude panning” (VBAP). After calculating panning gains, the mono signal is reproduced form the relevant loudspeakers with corresponding weighting.

It has been found that most panning techniques reproduce point-like sounding signals (objects) in space. Moreover, it has been found that, frequently however, it is desired to change the size of an object, make it sound more diffused, change the perceived distance or achieve other psycho-acoustical effects. Thus, the object should (or sometimes has to) sound not only point-like, but from a wider reproduction angle.

FIG. 1 shows a graphic representation of different object spread configurations. In the upper row, at reference symbols 100, 101, 102, an object with three different spread values is shown. In the lower row, at reference symbols 104 and 105, the object is spread non-uniformly on the reproduction sphere.

In other words, FIG. 1 depicts different object spread configurations independent of the reproduction loudspeaker setup. At reference numeral 100, a point-like sounding object is depicted. At reference numerals 101 and 102, the object is uniformly spread over wider/higher reproduction angles. At reference numeral 104, the object is spread vertically, and at reference numeral 105 horizontally.

In view of this situation, there is a need to create a concept which provides an improved tradeoff between hearing impression and computational complexity.

### SUMMARY

An embodiment may have an audio object renderer for determining loudspeaker gains for an inclusion of one or more audio object signals into a plurality of loudspeaker signals on the basis of an object position information and an object feature information, wherein the audio object renderer is configured to obtain panned object loudspeaker gains using a point source panning of the audio object, wherein the audio object is considered as a point source in the point source panning, and wherein the object feature information is neglected in the point source panning; wherein the point source panning uses the object position information; wherein the audio object renderer is configured to obtain object feature information loudspeaker gains, wherein the audio object is spread over an extended region, considering the object feature information; wherein the audio object renderer is configured to combine the panned object loudspeaker gains and the object feature information loudspeaker gains in such a manner, that there is a contribution of the panned object loudspeaker gains, in order to obtain combined loudspeaker gains; wherein the determination of the object feature information loudspeaker gains considers an extension of the audio object.

Another embodiment may have an audio object renderer for determining loudspeaker gains for an inclusion of one or more audio object signals into a plurality of loudspeaker signals on the basis of an object position information and an object feature information, wherein the audio object renderer is configured to obtain panned object loudspeaker gains using a point source panning of the audio object, wherein the audio object is considered as a point source in the point source panning, and wherein the object feature information is neglected in the point source panning; wherein the point source panning uses the object position information; wherein the audio object renderer is configured to obtain spread object loudspeaker gains, wherein the audio object is spread over an extended region, considering the object position information and the object feature information; wherein the audio object renderer is configured to combine the panned object loudspeaker gains and the spread object loudspeaker gains in such a manner, that there is a contribution of the panned object loudspeaker gains, in order to obtain combined loudspeaker gains; wherein the determination of the spread object loudspeaker gains considers an extension of the audio object.

Another embodiment may have an audio object renderer for determining loudspeaker gains for an inclusion of one or more audio object signals into a plurality of loudspeaker signals on the basis of an object position information and a spread information, wherein the audio object renderer is configured to obtain panned object loudspeaker gains using a point source panning of the audio object, wherein the audio object is considered as a point source in the point source panning, and wherein the spread information is neglected in the point source panning; wherein the point source panning uses the object position information; wherein the audio object renderer is configured to obtain spread object loudspeaker gains, wherein the audio object is spread over an extended region, considering the object position information and the spread information; wherein the audio object renderer is configured to combine the panned object loudspeaker gains and the spread object loudspeaker gains in such a manner, that there is a contribution of the panned object loudspeaker gains, in order to obtain combined loudspeaker gains; wherein the determination of the spread object loudspeaker gains considers an extension of the audio object.

According to another embodiment, a method for determining loudspeaker gains for an inclusion of one or more audio object signals into a plurality of loudspeaker signals on the basis of an object position information and an object feature information may have the steps of: obtaining panned object loudspeaker gains using a point source panning of the audio object, wherein the audio object is considered as a point source in the point source panning, and wherein the object feature information is neglected in the point source panning; wherein the point source panning uses the object position information; obtaining object feature information loudspeaker gains, wherein the audio object is spread over an extended region, considering the object feature information; combining the panned object loudspeaker gains and the object feature information loudspeaker gains in such a manner, that there is a contribution of the panned object loudspeaker gains, in order to obtain combined loudspeaker gains, wherein the determination of the object feature information loudspeaker gains considers an extension of the audio object.

According to another embodiment, a method for determining loudspeaker gains for an inclusion of one or more audio object signals into a plurality of loudspeaker signals on the basis of an object position information and an object feature information may have the steps of: obtaining panned object loudspeaker gains using a point source panning of the audio object, wherein the audio object is considered as a point source in the point source panning, and wherein the object feature information is neglected in the point source panning; wherein the point source panning uses the object position information; obtaining spread object loudspeaker gains, wherein the audio object is spread over an extended region, considering the object position information and the object feature information; combining the panned object loudspeaker gains and the spread object loudspeaker gains in such a manner, that there is a contribution of the panned object loudspeaker gains, in order to obtain combined loudspeaker gains, wherein the determination of the spread object loudspeaker gains considers an extension of the audio object.

According to another embodiment, a method for determining loudspeaker gains for an inclusion of one or more audio object signals into a plurality of loudspeaker signals on the basis of an object position information and a spread information may have the steps of: obtaining panned object loudspeaker gains using a point source panning of the audio object, wherein the audio object is considered as a point source in the point source panning, and wherein the spread information is neglected in the point source panning; wherein the point source panning uses the object position information; obtaining spread object loudspeaker gain, wherein the audio object is spread over an extended region, considering the object position information and the spread information; combining the panned object loudspeaker gains and the spread object loudspeaker gains in such a manner, that there is a contribution of the panned object loudspeaker gains, in order to obtain combined loudspeaker gains; wherein the determination of the spread object loudspeaker gains considers an extension of the audio object.

A non-transitory digital storage medium having a computer program stored thereon to perform any of the inventive methods when said computer program is run by a computer.

Another embodiment may have an audio object renderer for determining loudspeaker gains for an inclusion of one or more audio object signals into a plurality of loudspeaker signals on the basis of an object position information and a spread information, wherein the audio object renderer is configured to obtain panned object loudspeaker gains using a point source panning of the audio object, wherein the audio object is considered as a point source in the point source panning, wherein the spread information is neglected, and wherein a single loudspeaker is selected for a playback of an audio object or wherein an audio object is distributed to a plurality of loudspeakers which are closest to the audio object, wherein the panned object loudspeaker gains are based on the object position information; wherein the audio object renderer is configured to obtain spread object loudspeaker gains based on the object position information and the spread information, wherein the audio object is spread over an extended region; wherein the audio object renderer is configured to combine the panned object loudspeaker gains and the spread object loudspeaker gains in such a manner, that there is a contribution of the panned object loudspeaker gains, namely that the contribution of the panned object loudspeaker gains in the combination is non-zero, in order to obtain combined loudspeaker gains; wherein the determination of the spread object loudspeaker gains considers an extension of the audio object; wherein the audio object renderer is configured to provide the combined loudspeaker gains on the basis of both the point source panning of the audio object signal and a spreading of the audio object signal; and wherein the determination of the spread object loudspeaker gains spreads the audio object over a larger number of speakers than the determination of the panned object loudspeaker gains.

An embodiment according to the invention creates an audio object renderer for determining loudspeaker gains describing gains for an inclusion of one or more audio object signals into a plurality of loudspeaker signals on the basis of an object position information and an object feature information. The audio object renderer is configured to obtain panned object loudspeaker gains using a point source panning of the audio object. The audio object renderer is configured to obtain object feature information loudspeaker gains (for example, loudspeaker gains considering an extension and/or a perceived extension and/or a perceived angular extension and/or a diffuseness and/or a blur, e.g. of one or more audio objects under consideration) considering the object feature information (1212). For example, the object feature information may describe a divergence, e.g. a distribution of a source (or of an audio object, or of sound originating from an audio object) to a plurality of points, which may, for example, correspond to a broadening of the source. For example, an object, or a perception of the object, may be enlarged in accordance with the object feature information. Generally speaking, for example, the object feature information may represent a spread and/or an extent and/or a diffuseness of an audio object, and the object feature information loudspeaker gains may take into consideration this spread and/or extent and/or diffuseness of the audio object. Alternatively, or in addition, the object feature information may, for example, describe the a distance of an audio object, and this distance may, for example, be converted into a spread in a preparatory step, wherein this spread may then be considered in the provision of the object feature information loudspeaker gains. As another option, however the object feature information loudspeaker gains could also be directly derived from the distance.

The audio object renderer is further configured to combine the panned object loudspeaker gains (202a,1232,g) and the object feature information loudspeaker gains (206a,1242,gOS) in such a manner, that there is a contribution of the panned object loudspeaker gains, in order to obtain combined loudspeaker gains (214,1214,1214a-c).

This embodiment according to the invention is based on the finding that a good comprise between computational complexity and an achievable hearing impression can be obtained by obtaining object feature information loudspeaker gains (which may correspond to spread object loudspeaker gains), which describe intensities of an object signal from an audio object in different loudspeaker signals associated with different loudspeakers, on the basis of both panned object loudspeaker gains and spread object loudspeaker gains. In particular, by the usage of panned object loudspeaker gains, which typically provide for a “point source” hearing impression, a localization of an audio object by a user can be facilitated. For example, the derivation of the panned object loudspeaker gains may use a point source panning of the audio object, which may, for example, select a single loudspeaker for the playback of an audio object, or which may, for example, distribute an audio object to a plurality of loudspeakers which are closest to the audio object (while, for example, leaving loudspeakers that are not the closest loudspeakers, closest to the audio object, unused). Thus, the “point source” panning of the audio object typically provides panned object loudspeaker gains, wherein only loudspeaker gains of a few loudspeakers that are closest to an object position are non-zero.

In addition, the audio object renderer also obtains object feature information object loudspeaker gains, wherein the object is spread over an extended region, for example, over an extended range of azimuth angles and/or over an extended range of elevation angles. Accordingly, the determination of the object feature information object loudspeaker gains considers an extension of the audio object, which may, for example, be derived from the object feature information. The determination of the object feature information object loudspeaker gains typically spreads the audio object over a larger number of speakers than the determination of the panned object loudspeaker gains, because the determination of the object feature information object loudspeaker gains considers the extension of the audio object and typically uses a steady (e.g., steadily decaying) distribution characteristic which is comparatively broad (for example, even broader than an extension of the audio object under consideration).

Thus, by combining the panned object loudspeaker gains, which are based on a point source panning of an audio object, and the object feature information object loudspeaker gains, which consider an extension of the audio object, a good localization of the audio object can be achieved (even for objects having a comparatively large extension), and it is still possible to perceive the extension of the audio object. This is particularly true in situations in which there are multiple uses, and/or in which a user is not located at a “sweet spot” of a listening arrangement. By introducing a contribution the panned object loudspeaker gains, e.g., in dependent from a object feature information, it can be achieved that the localization of the audio object is ensured, and is possible even for listeners which are not at the sweet spot location.

Moreover, it should be noted that the object feature information typically allows to determine or estimate an extension of an audio object. For example, the object feature information may indicate a type of object, wherein this type of object may imply parameters for the determination of the spread object loudspeaker gains (for example, a spread parameter). For example, the object feature information may allow for a distinction between comparatively small objects and comparatively large objects. Alternatively or in addition, the object feature information may allow for a distinction between near objects and far objects, which may also imply one or more parameters for the determination of the spread object loudspeaker gains. The object feature information may optionally describe a “smeared” or “diffuse” extension of an audio object, or a distribution of the audio object to a plurality of localized positions.

To conclude, the audio object renderer may derive one or more parameters for the determination of the object feature information object loudspeaker gains from the object feature information. Accordingly, the object feature information allows to properly adjust the derivation of the spread object loudspeaker gains, such that the object can both be localized, due to the provision of the panned object loudspeaker gains, and can be perceived with an appropriate extension due to the consideration of the object feature information in the provision of the object feature information loudspeaker gains.

In an embodiment, the audio object renderer is configured to obtain object feature information loudspeaker gains additionally considering the object position information. This, both the extension and the position of the audio object can be considered.

In an embodiment, said object feature information is audio object spread information. This allows for a particularly efficient computation, since it is not needed to map an “abstract” object feature information onto an object spread information in this case.

An embodiment according to the invention creates an audio object renderer for determining loudspeaker gains (e.g. combined loudspeaker gains or resulting loudspeaker gains) describing gains for an inclusion of one or more audio object signals into a plurality of loudspeaker signals on the basis of an object position information (e.g. azimuth (azi), elevation (ele)), which may, for example, be provided in spherical coordinates, e.g. using an azimuth value azi and an elevation value ele, and an object feature information. The object feature information may, for example, be an information indicating whether the object is small or extended, e.g. an object size value, or the object feature information may, for example, be an object distance information, which can be mapped onto a spread value (e.g. onto a spread angle information describing a spread in an azimuth direction, e.g. spreadAngleAzi, and/or onto a spread angle information describing a spread in an elevation direction, e.g. spreadAngleEle). However, other types of object feature information are also possible.

The audio object renderer is configured to obtain panned object loudspeaker gains (for example, also designated as “object loudspeaker gains”, or represented by a vector g) using a point source panning of the audio object. In the point source panning, the audio object may, for example, be considered as a point source, wherein the spread information is, for example, neglected and wherein a signal of the audio object is associated to two or more loudspeakers in an environment of the object position of the audio object by an appropriate choice of the panned object loudspeaker gains.

The audio object renderer is configured to obtain spread object loudspeaker gains (also designated, for example, as spread loudspeaker gains, or represented as a vector gOS) considering the object position information and the object feature information.

The audio object renderer is configured to combine the panned object loudspeaker gains (e.g. g) and the spread object loudspeaker gains (e.g. gOS) in such a manner, that there is a contribution of the panned object loudspeaker gains (e.g. independent from the object feature information), in order to obtain combined loudspeaker gains.

This embodiment according to the invention is based on the finding that a good comprise between computational complexity and an achievable hearing impression can be obtained by obtaining spread object loudspeaker gains, which describe intensities of an object signal from an audio object in different loudspeaker signals associated with different loudspeakers, on the basis of both panned object loudspeaker gains and spread object loudspeaker gains. In particular, by the usage of panned object loudspeaker gains, which typically provide for a “point source” hearing impression, a localization of an audio object by a user can be facilitated. For example, the derivation of the panned object loudspeaker gains may use a point source panning of the audio object, which may, for example, select a single loudspeaker for the playback of an audio object, or which may, for example, distribute an audio object to a plurality of loudspeakers which are closest to the audio object (while, for example, leaving loudspeakers that are not the closest loudspeakers, closest to the audio object, unused). Thus, the “point source” panning of the audio object typically provides panned object loudspeaker gains, wherein only loudspeaker gains of a few loudspeakers that are closest to an object position are non-zero.

In addition, the audio object renderer also obtains spread object loudspeaker gains, wherein the object is spread over an extended region, for example, over an extended range of azimuth angles and/or over an extended range of elevation angles. Accordingly, the determination of the spread object loudspeaker gains considers an extension of the audio object, which may, for example, be derived from the object feature information. The determination of the spread object loudspeaker gains typically spreads the audio object over a larger number of speakers than the determination of the panned object loudspeaker gains, because the determination of the spread object loudspeaker gains considers the extension of the audio object and typically uses a steady (e.g., steadily decaying) distribution characteristic which is comparatively broad (for example, even broader than an extension of the audio object under consideration).

Thus, by combining the panned object loudspeaker gains, which are based on a point source panning of an audio object, and the spread object loudspeaker gains, which consider an extension of the audio object, a good localization of the audio object can be achieved (even for objects having a comparatively large extension), and it is still possible to perceive the extension of the audio object. This is particularly true in situations in which there are multiple uses, and/or in which a user is not located at a “sweet spot” of a listening arrangement. By introducing a contribution the panned object loudspeaker gains, e.g., in dependent from a spread information or independent from an object feature information, it can be achieved that the localization of the audio object is ensured, and is possible even for listeners which are not at the sweet spot location.

Moreover, it should be noted that the object feature information typically allows to determine or estimate an extension of an audio object. For example, the object feature information may indicate a type of object, wherein this type of object may imply parameters for the determination of the spread object loudspeaker gains (for example, a spread parameter). For example, the object feature information may allow for a distinction between comparatively small objects and comparatively large objects. Alternatively or in addition, the object feature information may allow for a distinction between near objects and far objects, which may also imply one or more parameters for the determination of the spread object loudspeaker gains.

To conclude, the audio object renderer may derive one or more parameters for the determination of the spread object loudspeaker gains from the object feature information. Accordingly, the object feature information allows to properly adjust the derivation of the spread object loudspeaker gains, such that the object can both be localized, due to the provision of the panned object loudspeaker gains, and can be perceived with an appropriate extension due to the consideration of the object feature information in the provision of the spread object loudspeaker gains.

To conclude, the above-described audio object renderer allows for a determination of loudspeaker gains which provide a good hearing impression while keeping a computational complexity reasonably small.

To further conclude, the invention generally creates an object renderer, which panns an object using VBAP, which then determines object feature gains for the object, and combines these in relationship with the VBAP-panned object.

Another embodiment according to the invention creates an audio object renderer for determining loudspeaker gains (e.g. combined loudspeaker gains or resulting loudspeaker gains) describing gains for an inclusion of one or more audio object signals into a plurality of loudspeaker signals on the basis of an object position information (e.g. azimuth (azi), and/or elevation (ele)), which may, for example, be provided in spherical coordinates (e.g. using an azimuth value azi and an elevation value ele) and a spread information (e.g. a spread angle information describing a spread in an azimuth direction, e.g. spreadAngleAzi, and/or a spread angle information describing a spread in an elevation direction, e.g. spreadAngleEle).

The audio object renderer is configured to obtain panned object loudspeaker gains (also designated as “object loudspeaker gains”, or represented by a vector g) using a point source panning of the audio object (in which, for example, the audio object is considered as a point source, in which, for example, the spread information is neglected and in which, for example, a signal of the audio object is associated to two or more loudspeakers in an environment of the object position of the audio object by an appropriate choice of the panned object loudspeaker gains).

The audio object renderer is configured to obtain spread object loudspeaker gains (also designated, for example, as spread loudspeaker gains, or represented, for example, as a vector gOS) considering the object position information and the spread information.

The audio object renderer is configured to combine the panned object loudspeaker gains (e.g. g) and the spread object loudspeaker gains (e.g. gOS) in such a manner, that there is a contribution of the panned object loudspeaker gains (e.g. independent from the spread information), in order to obtain combined loudspeaker gains.

This audio object renderer is based on the same considerations as the above-mentioned audio object renderer. However, instead of the object feature information, a spread information is evaluated, which directly describes how an object should be spread out. For example, the spread information may be a spread angle information describing a spread in an azimuth direction and/or a spread in an elevation indirection. Alternatively, the spread information may also be a solid angle information, or may specify the size of the object in any other form (e.g., using an absolute size information and/or distance information, or the like). Accordingly, it is possible to obtain the combined loudspeaker gains, such that the combined loudspeaker gains allow for a representation of an object signal with a good hearing impression, enabling the listener to localize the object and to perceive the object in an appropriate extension. For example, this can be achieved by using a panning, even if a spread the object is sufficiently broad.

In an embodiment of the audio object renderers mentioned before, the audio object renderer is configured to evaluate one or more gain functions (e.g. one or more polynomial functions or one or more parabolic functions; e.g. a spread weighting curve), which map differences between positions of supporting points (e.g. artificially generated supporting points; e.g. designated with SSP) and an object position onto one or more spread gain value contributions (e.g. aziGain(naz) or eleGain(nel)), and to determine the spread object loudspeaker gains (e.g. gOS) on the basis of the one or more spread gain value contributions.

By using positions of supporting points and by evaluating one or more gain functions, which may map differences between positions of supporting points and object positions onto one or more spread gain value contributions, it is possible to have a uniform and computationally highly efficient computation scheme for determining the spread gain values. The gain functions may, for example, weight the angular difference between the object positions and the positions of the supporting points (for example, both in terms of an azimuth angle and an elevation angle) and thereby allow for a simple but accurate determination of spread gain value contributions. Moreover, but using supporting point positions, rather than the loudspeaker positions, a high degree of uniformity can be ensured, which typically helps to reduce the algorithmic complexity. For example, a mapping of signal gains associated with the support points to signal gains associated with the actual loudspeakers can be pre-computed and does not need to be re-computed for each audio object. However, the determination of gain values associated with the typically geometrically regular supporting points is possible using an algorithm having a comparatively low complexity. Thus, the determination of the combined loudspeaker gains is possible with a high degree of efficiency.

In an embodiment of the audio object renderers mentioned before, the audio object renderer is configured to determine a weighting of spread object loudspeaker gains in a combination with panned object loudspeaker gains in dependence on a spread in a first direction (e.g. spread_{azi}) and in dependence on a spread in a second direction (e.g. spreadₑₗₑ).

Accordingly, it can be decided, which importance (or weight) the determination of the spread object loudspeaker gains has when compared to the determination of the panned object loudspeaker gains. For example, for large spread angles, the relative importance of the spread object loudspeaker gains in the combination can be increased when compared to a situation in which the spread is comparatively small. Moreover, by adjusting the weighting of the spread object loudspeaker gains, it can be ensured that a (relative) contribution of the panned object loudspeaker gains is reduced for cases in which the spread is comparatively wide, to thereby avoid a bad hearing impression. In contrast, when the spread is comparatively small, the (relative) contribution of the panned object loudspeaker gains can be increased, to thereby reflect the localized nature of an audio object. Accordingly, it is also possible to have a smooth transition if, for example, the spread of an audio object may rise over time, which may, for example, be the case if the audio object under consideration is a moving audio object. To conclude, the determination of the weighting of the spread object loudspeaker gains in a combination with panned object loudspeaker gains allows for achieving a good hearing impression even in case of widely-spread objects.

In an embodiment of the audio object renderer mentioned before, the audio object renderer is configured to determine a weighting of spread object loudspeaker gains in a combination with panned object loudspeaker gains in dependence on a product of a spread angle (or normalized spread angle or normalized spread extent or weighted spread extent) in a first direction (e.g. spread_{azi}) and of a spread angle (or normalized spread angle or normalized spread extent or weighted spread extent) in a second direction (e.g. spreadₑₗₑ) (at least over a range of spread angles below predetermined thresholds, e.g. gᵣₑₛ).

It has been found that a product of a spread angle in a first direction and of an angle in a second direction well-reflects the spread characteristic of an audio object. In particular, if an audio object comprises a very small spread angle in one of the directions, the product will be comparatively small, and the objects will be considered as being comparatively localized. However, it has been found that the product of the spread angle in a first direction and of a spread angle in a second direction (which may, for example, be perpendicular to the first direction) works well for an adjustment of the weighting of the spread object loudspeaker gains in the combination with panned object loudspeaker gains and can be determined with very high computational efficiency.

In an embodiment of the audio object renderer mentioned before, the audio object renderer is configured to add panned object loudspeaker gains (e.g. a vector g of panned object loudspeaker gains), weighted with a fixed weight (e.g. 1), and spread object loudspeaker gains (e.g. a vector gOS), weighted with a variable weight (e.g. attenGain or g_{atten.}) which is dependent on a spread angle in a first direction (e.g. spread_{azi}) and a spread angle in a second direction (e.g. spreadₑₗₑ), and which may, optionally, be limited to be not larger than the fixed weight, for example, like shown in the equation for g_{atten.}.

Using such an approach, it can be achieved that the panned object loudspeaker gains have a sufficient weight in the combination irrespective of the spread angles, while it is still possible to vary the effective (relative) weighting between the panned object loudspeaker gains and the spread object loudspeaker gains. However, by ensuring that the contribution of the panned object loudspeaker gains does not fall below a certain minimum weight ensures that an object can be reasonably be localized, irrespective from a listener's position in a speaker environment. This allows to avoid a strong degradation of an audio impression while maintaining the possibility to adjust a perceived extension of the audio objects.

In an embodiment of the audio object renderer mentioned before, the audio object renderer is configured to normalize a result of the addition of the panned object loudspeaker gains, weighted with a fixed weight, and of the spread object loudspeaker gains, weighted with a variable weight (e.g by dividing the result of the addition by the norm of the result of the addition).

Using such a normalization, it can be achieved that a total energy, or a total perceived loudness, is substantially independent from a spreading of one or more audio objects. Thus, an adjustment of a loudness can be made separately from the adjustment of the spreading.

In an embodiment of the audio object renderer mentioned before, the audio object renderer is configured to determine a weighting attenGain of spread object loudspeaker gains in a combination with panned object loudspeaker gains according to

attenGain=0.89f*min(c₁,max(spread_{azi},spreadₑₗₑ)/+0.11f*min(c₂,min(spread_{azi},spreadₑₗₑ)/gᵣₑₛ₂);

wherein c₁ is a predetermined value (e.g. 1), which may, for example, limit the first factor contributing to attenGain, wherein c₂ is a predetermined value (e.g. 1), which may, for example, limit the second factor contributing to attenGain, wherein gᵣₑₛ₁ is a predetermined value (e.g an azimuth spacing of supporting point positions, e.g. 45 degrees, e.g. a SSP grid resolution), wherein gᵣₑₛ₂ is a predetermined value (e.g. an elevation spacing of supporting point positions, e.g. 45 degrees, e.g. a SSP grid resolution), wherein spread is a spreading angle of an audio object in an azimuth direction, wherein spreadₑₗₑ is a spreading angle of the audio object in an elevation direction, wherein min(.) is a minimum operator, and wherein max(.) is a maximum operator.

Using such a determination of the weighting of the spread loudspeaker gains in a combination with panned object loudspeaker gains, a particularly good hearing impression can be achieved. In this computation, the weighting depends both on a smaller one of the spreading angles and a larger one of the spreading angles, wherein the larger one of the spreading angles is given greater weight. It has been found that such an assessment of a two-dimensional spread (i.e., such a determination of the weighting of spread object loudspeaker gains) results in a relative weighting of spread object loudspeaker gains and panned object loudspeaker gains which brings along a good hearing impression.

However, it should be noted that the factors 0.89f and 0.11f could be changed, wherein the first factor, which is applied to min(c₁, max(spread_{azi}, spreadₑₗₑ)/gᵣₑₛ₁) should be larger than the second factor (advantageously, by at least 50%).

In an embodiment of the audio object renderer mentioned before, the audio object renderer is configured to increase a relative contribution of the spread object loudspeaker gains when compared to the panned object loudspeaker gains with increasing spread angles of the audio object (e.g. with increasing product of the spread angle in azimuth direction and the spread angle in elevation direction), e.g. up to a point where the spread angle in azimuth direction and the spread angle in elevation direction reach predetermined values.

It has been found that such a concept results in a particularly good hearing impression since, for example, both a spread angle in a first direction (e.g., azimuth direction) and the spread angle in a second direction (e.g., elevation direction) is considered and contributes to the weight of the contribution of the spread object loudspeaker gains in the above-mentioned combination of panned object loudspeaker gains and spread object loudspeaker gains. However, by applying certain limits (which may be defined by “predetermined values”), it can still be avoided to use an excessive weighting for the spread object loudspeaker gains which would degrade the possibility to localize a sound source.

In an embodiment of the audio object renderer mentioned before, the audio object renderer is configured to obtain spread object loudspeaker gains (also designated as spread loudspeaker gains, or represented as a vector gOS) considering the object position information and the spread information and using a representation (e.g. aziSSP and/or eleSSP) of supporting point positions in polar coordinates, and the audio object renderer is configured to provide the loudspeaker gains on the basis of the spread object loudspeaker gains.

It has been found that a representation of supporting point positions in polar coordinates typically strongly facilitates the computations, since it is very helpful to represent the spreading in terms of azimuthal spreading an elevational spreading. Furthermore, when using polar coordinates, it is often not needed to consider the radius component, because it is often appropriate to assume a predetermined radius for supporting point positions.

Accordingly, it is, for example, possible to represent the supporting points using only two polar coordinates, for example, an azimuth angle and an elevation angle. Thus, a computational complexity is typically reduced.

In an embodiment of the audio object renderer mentioned before, the audio object renderer is configured
to evaluate one or more angle differences (e.g. diffCLKDir, diffAntiCLKDir, and optionally diffCLKDir+(n−1)*Spread.openAngle and diffAntiCLKDir+(n−1)Spread.openAngle) between an azimuth position of the audio object and of one or more supporting points, and/or
to evaluate one or more angle differences (e.g. diffCLKDir, diffAntiCLKDir) between an elevation position of audio object and elevation positions of one or more supporting points in order to obtain the spread loudspeaker gains.

It has been found that evaluating such angle differences can be performed with little computational effort. Also, it has been found that the angle differences can be mapped, with moderate effort, onto values or gain values associated with the supporting points and describing, for example, how an audio signal of an audio object should be rendered to the supporting points. Moreover, in computationally efficient implementations, the supporting points can be arranged in highly regular manner, such that, for example, the azimuth angle differences to be evaluated are identical for different elevation angles, and such that, for example, the elevation angle differences to be evaluated are identical for different azimuth angles. Using such a concept, a particularly high computational efficiency can be reached, since azimuth angle differences only need to be evaluated for one elevation and elevation angle differences only need to be evaluated for one azimuth angle. Thus, the concept mentioned here can be helpful for reducing a computational effort, which facilitates an implementation of the concept in devices having small computational resources.

In an embodiment of the audio object renderer mentioned before, supporting point positions are arranged on a sphere within a tolerance of +/−10% or +/−20% of a radius of the sphere.

By using supporting points which are arranged on a sphere, it is typically not needed to explicitly consider a radius. Also, it has been found that such supporting point positions are particularly helpful if an extension of an audio object is expressed in terms of angle values (for example, an elevation angle value and an azimuth angle value). In contrast, using Cartesian coordinates would significantly increase the computational effort, since three spatial coordinates would need to be considered, and since it would typically be needed to apply computationally expensive trigonometric functions in the computation, to transition between Cartesian coordinates and angle representations.

In an embodiment of the audio object renderer mentioned before, supporting point positions comprise a uniform azimuth angle spacing (e.g. of 45 degrees) along a circle having a constant elevation (e.g. an elevation −135 degrees or −90 degrees or −45 degrees or 0 degrees or 45 degrees or 90 degrees or 135 degrees) and a constant radius (e.g. a normalized radius of 1), or even along a plurality of circles having different constant elevations and a constant radius.

Alternatively, or in addition, supporting point positions comprise a uniform elevation angle spacing (e.g. of 45 degrees) along a circle having a constant azimuth (e.g. an azimuth angle −135 degrees or −90 degrees or −45 degrees or 0 degrees or 45 degrees or 90 degrees or 135 degrees) and a constant radius (e.g. a normalized radius of 1), or even along a plurality of circles having different constant azimuth angles and a constant radius.

By using a uniform azimuth angle spacing along a circle having a constant elevation, and by using a uniform elevation angle spacing along a circle having a constant azimuth, a computational effort can be reduced. Moreover, if there is a uniform azimuth angle spacing along a plurality of circles having different constant elevations and a constant radius, a computational effort can be further reduced while still maintain a good coverage of a whole sphere surface, because a significant part of the computations does not need to be repeated for the plurality of circles having different elevations and a constant radius if they all have a uniform azimuth spacing. For example, a computation of azimuth angle differences only needs to be computed for one of the circles, and results can also be applied for the other circles having the same uniform azimuth angle spacing like the first circle under consideration. The same also applies for a plurality of circles having different constant azimuth angles and a constant radius, and advantageously identical uniform elevation angle spacing. Elevation angle differences only need to be computed once, and results thereof can be taken over for supporting point positions on another circle having the same uniform elevation angle spacing. Consequently, computations can be performed for a large number of supporting points with very small computational effort.

In an embodiment of the audio object renderer mentioned before, the object renderer is configured to obtain the spread object loudspeaker gains such that an audio object is spread over a region which extends in a first hemisphere, in which the audio object is located, and which also extends in a second hemisphere, an azimuthal position of which is opposite to the first hemisphere. For example, the first hemisphere may be a hemisphere in front of a listener's position, e.g. having azimuth angles between −90 degree and +90 degree, wherein 0 degree is the viewing direction of the listener, and, for example, the second hemisphere may be a hemisphere behind the listener's position, e.g. having azimuth angles between −180 degree and −90 degree, or between 90 degree and 180 degree, or vice versa.

By spreading an audio object over a region which extends in a first hemisphere and which also extends in a second hemisphere, objects can effectively be spread over the head of the user or below the user. Accordingly, a hearing impression can be achieved which gives the listener the impression that an extended object is above his head, which is so large that it is both in front of his head and behind his head. Thus, a particularly realistic hearing impression can be provided.

In an embodiment of the audio object renderer mentioned before, the audio object renderer is configured to use an extended elevation range between −180 degree and +180 degree.

By using an extended elevation range, discontinuities can be avoided and computations can be simplified, which may reduce a number of case distinctions and angle corrections. For example, it is much simpler to say (and mathematically or algorithmically represent) that an object should be rendered for a given azimuth angle and for elevations of 80 degrees and 100 degrees when compared to indicating that an object should be rendered for an elevation of 80 degrees at two opposite azimuth angles, for example, an azimuth angle of 0 degree and 180 degree). Thus, by doubling the elevation range, which normally extends from −90 degrees to +90 degrees, computations can be simplified, and a representation of computation results can be simplified.

In an embodiment of the audio object renderer mentioned before, the audio object renderer is configured to compute, for a given object position (e.g. defined by an azimuth value azi and an elevation value ele) and for a given spread (e.g. defined by spreadAngleAzi or spreadAngleEle)
a first set of azimuth gain values (e.g. aziGain) describing contributions to the spread gains (e.g. g_spd) for a plurality of azimuth values associated with supporting point positions or supporting point azimuth indices (e.g. naz) (e.g. using a polynomial function or a parabolic function, a width of which is adapted to an object spread width in an azimuth direction), which is associated with elevation values in an original elevation value range (e.g. −90 degree to +90 degree) which indicates no crossing of a pole of the spherical coordinate system, and
a second set of azimuth gain values (e.g. aziGainExtd) describing contributions to the spread gains for a plurality of azimuth values associated with supporting point positions or supporting point azimuth indices (e.g. naz) (e.g. using a polynomial function or a parabolic function, a width of which is adapted to an object spread width in an azimuth direction), which is associated with elevation values in an extended elevation value range (e.g. −180 degree to −90 degree and +90 degree to +180 degree) which indicates a crossing of one of the poles of the spherical coordinate system (e.g. a crossing of a pole at an elevation of −90 degree, or a crossing of a pole at an elevation of +90 degree), which may, for example correspond to a spreading of an audio object over one of the poles of the spherical coordinate system.

The audio object renderer is also configured to derive the spread gains (which are, for example, used in the determination of the spread object loudspeaker gains gOS) using the first set of azimuth gain values (e.g. aziGain(naz)) and using the second set of azimuth gain values (e.g. aziGainExtd).

By computing two sets of azimuth gain values, one for (or associated with) an original (or basic) elevation value range, and one for (or associated with) an extended elevation value range, a spreading of an audio object over the head of a listener (or below a listener) can be computed in a particularly efficient manner. In particular, it has been found that the sets of azimuth gain values can be used for derivation of the spread gains in an efficient manner, for example, using a predefined combination mapping. On the other hand, since elevation values in the extended elevation value range can easily be derived from elevation values in the original elevation value range using an addition or a subtraction (for example) without a distinction of multiple cases and without a change of an azimuth value, computations and a representation of results is facilitated.

For example, when spreading an audio object over the head of a user, a spreading over the head of the user can simply be computed by using elevation values larger than 90 degrees. Accordingly, an object having a given azimuth angle (for example, an azimuth angle which lies in a range between −90 degree and +90 degrees) and a positive elevation angle between 0 degrees and 90 degrees, can easily be extended over the head of the user while maintaining the azimuth angle unchanged (within the range between −90 degrees and +90 degrees) using an elevation angle which is larger than 90 degrees. Accordingly, elevation gain values associated with elevation values in the extended elevation value range (in this example, between +90 degrees and +180 degrees) can be obtained as an intermediate quality, and can later be mapped back, for example, towards supporting points or towards a coordinate system using elevation angles only within the original elevation value range using a combination with azimuth gain values of the second set of azimuth gain values. To conclude, the described concept significantly improves the computational efficiency when spreading an audio object over the head of the user (or below the user).

In an embodiment of the audio object renderer mentioned before, the audio object renderer is configured to compute, for a given object position (e.g. defined by an azimuth value azi and an elevation value ele) and for a given spread (e.g. defined by spreadAngleAzi or spreadAngleEle)
a first set of elevation gain values (e.g. eleGain) describing contributions to the spread gains for a plurality of elevation values associated with supporting point positions or loudspeaker azimuth indices or supporting point elevation indices (e.g. nel) (e.g. using a parabolic function a width of which is adapted to an object spread width in an azimuth direction), which is associated with elevation values in an original elevation value range (e.g. −90 degree to +90 degree) which indicates no crossing of a pole of the spherical coordinate system], and
a second set of elevation gain values (e.g. eleGainExtd) describing contributions to the spread gains for a plurality of elevation values associated with supporting point positions or loudspeaker elevation indices or supporting point elevation indices (e.g. nel)(e.g. using a parabolic function a width of which is adapted to an object spread width in an azimuth direction), which is associated with elevation values in an extended elevation value range (e.g. −180 degree to −90 degree and +90 degree to +180 degree) which indicates a crossing of one of the poles of the spherical coordinate system (e.g. a crossing of a pole at an elevation of −90 degree, or a crossing of a pole at an elevation of +90 degree), which may, for example, correspond to a spreading of an audio object over one of the poles of the spherical coordinate system.

The audio object renderer is also configured to derive the spread gains using the first set of azimuth gain values (aziGain(naz)), using the second set of azimuth gain values (aziGainExtd), using a first set of elevation gain values (eleGain(nel)), and using the second set of elevation gain values (eleGainExtd(nel)).

This embodiment is based on similar considerations like the embodiment computing azimuth gain values.

In an embodiment of the audio object renderer mentioned before, the audio object renderer is also configured to combine (e.g multiplicatively) values (e.g. corresponding values, e.g. aziGain(naz), eleGain(nel)) of the first set of azimuth gain values and of the first set of elevation gain values and to combine (e.g. corresponding) values (e.g. aziGainExtd(naz), eleGainExtd(nel)) of the second set of azimuth gain values and of the second set of elevation gain values.

Using such a combination, values which are associated with a same position can be combined (e.g., summed). For example, each supporting point position may be referenced by a combination of a first azimuth value and a first elevation value in the original elevation value range, and by a combination of a second azimuth value and a second elevation value in the extended elevation value range. For example, a point (for example, supporting point position) can be designated by an azimuth angle of +10 degrees in an elevation angle of +80 degrees, and can also be designated by an azimuth angle of −170 degrees and an elevation angle of +100 degrees. In other words, it is possible to combine values, e.g., azimuth gain values and elevation gain values, associated with the same point but referenced by different combinations of azimuth values and elevation values.

For example, the second set of azimuth gain values may comprise the same azimuth gain values, which are included in the first set of azimuth gain values but associated with opposite directions (or azimuth angle values). For example, the second set of azimuth gain values may indicate, at an azimuth angle of −170 degrees (or, generally x−180 degree or x+180 degree), the same gain which the first set of azimuth gain values indicates at an azimuth angle of +10 degrees (or, generally x degree). However, the actual position designed by an azimuth angle of +10 degree and an elevation angle of +80 degrees (or, generally, y degree) is actually the same as the position designated by an azimuth angle of −170 degrees and an extended elevation value range elevation value of +100 degrees (or, generally 180 degree−y). Consequently, an elevation gain value associated with an elevation value in the extended elevation value range should be combined with an azimuth gain value associated with an “opposite” azimuth angle. Accordingly, the second set of azimuth gain values actually describes contributions to the spread gains for “opposite” azimuth angle values.

To conclude, by combining values of the first set of azimuth gain values and of the first set of elevation gain values, and by combining values of the second set of azimuth gain values and of the second set of elevation gain values, two pairs of values associated with the same position (described by different azimuth values and elevation values) can be combined, to thereby obtain meaningful gain values associated with the supporting points.

In an embodiment of the audio object renderer mentioned before, the second set of azimuth gain values represents an evolution of gain values over an azimuth angle which is shifted by 180 degrees when compared to an evolution of gain values over the azimuth angle represented by the first set of azimuth gain values.

By using such a representation of the azimuth gain values, using two sets of azimuth gain values, it can be considered that elevation values in the extended elevation value range designate the same point as elevation values in the original elevation value range when considering a modified azimuth angle. Thus, by using two sets of azimuth gain values representing an evolution of gain values over two shifted azimuth angle ranges allows for a simple and computationally efficient handling of elevation angles in the extended elevation angle range, because the “second set of azimuth gain values” can easily be combined with elevation gain values associated with the extended elevation angle range.

In an embodiment of the audio object renderer mentioned before, the first set of azimuth gain values represents an evolution of gain values over a range of 360 degrees in view of an azimuth object position and an azimuth spread angle with an angle accuracy determined by a number of loudspeakers or by a number of supporting points.

Alternatively, or in addition, the second set of azimuth gain values represents an evolution of gain values over a range of 360 degrees in view of an azimuth object position, rotated by 180 degrees, and an azimuth spread angle with an angle accuracy determined by a number of loudspeakers or by a number of supporting points.

By using a set of azimuth gain values which represents an evolution of gain values over a range of 360 degree, a full environment of a listener can be considered efficiently, and both audio objects in front of the listener and audio objects behind the listener can be considered.

By using such sets of azimuth gain values which represent an evolution of gain values over a range of 360 degree, it is also possible to handle a spreading of an audio object over the head of a user or below a user.

In an embodiment of the audio object renderer mentioned before, the first set of elevation gain values represents an evolution of gain values over an elevation range between −90 degree and +90 degree (e.g. for cases where the audio object has not been spread over a pole of a spherical coordinate system) in view of an elevation object position (which is in a range between −90 degree and +90 degree), and an elevation spread angle.

Alternatively or in addition, the second set of elevation gain values represents an evolution of gain values over an elevation range between −180 degree to −90 degree and between +90 degree and +180 degree (e.g. for cases where the audio object has been spread over a pole of a spherical coordinate system) in view of an elevation object position (which is in a range between −90 degree and +90 degree), and an elevation spread angle.

By using such sets of elevation gain values, a spreading of an object over the head of a user can easily be handled, because angle values can simply be added or subtracted without exceeding the range of elevation angles covered by the first set of elevation gain values and by the second set of elevation gain values.

An embodiment according to the invention creates a method for determining loudspeaker gains (e.g. combined loudspeaker gains or resulting loudspeaker gains) describing gains for an inclusion of one or more audio object signals into a plurality of loudspeaker signals on the basis of an object position information (e.g. azimuth (azi), elevation (ele))(which may, for example, be provided in spherical coordinates, e.g. using an azimuth value azi and an elevation value ele) and an object feature information (e.g. a spread angle information describing a spread in an azimuth direction, e.g. spreadAngleAzi, and/or a spread angle information describing a spread in an elevation direction, e.g. spreadAngleEle).

The method comprises obtaining panned object loudspeaker gains (also designated as “object loudspeaker gains”, or represented by a vector g) using a point source panning of the audio object (in which the audio object is considered as a point source, in which the spread information is neglected and in which a signal of the audio object is associated to two or more loudspeakers in an environment of the object position of the audio object by an appropriate choice of the panned object loudspeaker gains).

The method also comprises obtaining spread object loudspeaker gains (also designated as spread loudspeaker gains, or represented as a vector gOS) considering the object position information and the object feature information.

The method comprises combining the panned object loudspeaker gains (e.g. g) and the spread object loudspeaker gains (e.g. gOS) in such a manner, that there is a contribution of the panned object loudspeaker gains (independent from the spread information), in order to obtain combined loudspeaker gains.

This method is based on the same considerations as the above-mentioned corresponding apparatus.

Moreover, the method can optionally be supplemented by any of the features, functionalities and details described with respect to the above-mentioned corresponding apparatus, both individually and taken in combination.

An embodiment according to the invention creates a method for determining loudspeaker gains (e.g. combined loudspeaker gains or resulting loudspeaker gains) describing gains for an inclusion of one or more audio object signals into a plurality of loudspeaker signals on the basis of an object position information (e.g. azimuth (azi), elevation (ele))(which may, for example, be provided in spherical coordinates, e.g. using an azimuth value azi and an elevation value ele) and a spread information (e.g. a spread angle information describing a spread in an azimuth direction, e.g. spreadAngleAzi, and/or a spread angle information describing a spread in an elevation direction, e.g. spreadAngleEle).

The method comprises obtaining panned object loudspeaker gains (also designated as “object loudspeaker gains”, or represented by a vector g) using a point source panning of the audio object (in which the audio object is considered as a point source, in which the spread information is neglected and in which a signal of the audio object is associated to two or more loudspeakers in an environment of the object position of the audio object by an appropriate choice of the panned object loudspeaker gains).

The method comprises obtaining spread object loudspeaker gains (also designated as spread loudspeaker gains, or represented as a vector gOS) considering the object position information and the spread information.

The method comprises combining the panned object loudspeaker gains (e.g. g) and the spread object loudspeaker gains (e.g. gOS) in such a manner, that there is a contribution of the panned object loudspeaker gains (independent from the spread information), in order to obtain combined loudspeaker gains.

This method is based on the same considerations as the above-mentioned corresponding apparatus.

Moreover, the method can optionally be supplemented by any of the features, functionalities and details described with respect to the above-mentioned corresponding apparatus, both individually and taken in combination.

In an embodiment of the methods mentioned before, the method comprises evaluating one or more gain functions (e.g. one or more polynomial functions or one or more parabolic functions; e.g. a spread weighting curve), which map differences between positions of supporting points (e.g. artificially generated supporting points; SSP) and an object position onto one or more spread gain value contributions (e.g. aziGain(naz) or eleGain(nel)), and determining the spread object loudspeaker gains (e.g. gOS) on the basis of the one or more spread gain value contributions.

An embodiment according to the present invention creates a computer program for performing the methods mentioned before when the computer program runs on a computer.

The computer program can be supplemented by any of the features, functionalities and details described herein, both individually and taken in combination.

In the following, further embodiments according to the invention will be discussed. These embodiments can both be used individually and in combination with any of the other embodiments disclosed herein. In other words, optionally, any of the features, functionalities and details of the embodiments discussed in the following can optionally be introduced into any other embodiments disclosed herein, both individually and taken in combination.

An embodiment according to the invention creates an audio object renderer (200,1300) for determining loudspeaker gains (214,1214,1214a-c) describing gains for an inclusion of one or more audio object signals (1260) into a plurality of loudspeaker signals (1262a-1262c) on the basis of an object position information (210,1310, azi, ele) and an object feature information (1312). The object renderer is configured to obtain object feature information gains (314a, g_spd) using one or more polynomial functions having a degree which is smaller than or equal to three.

In an embodiment, the object renderer is configured to obtain the object feature information loudspeaker gains (206a,1242,gOS) using object feature gains (314a,g_spd), which are based on object feature gain contributions (302a, aziGain, 305a,eleGain,309a,aziGainExtd,311a,eleGainExtd).

In an embodiment, said object feature information is a spread information (212,1312,spreadAngleAzi, spreadAngleEle).

An embodiment according to the invention creates an audio object renderer for determining loudspeaker gains (e.g. combined loudspeaker gains) describing gains for an inclusion of one or more audio object signals into a plurality of loudspeaker signals on the basis of an object position information (e.g. azimuth (azi), elevation (ele))(which may, for example, be provided in spherical coordinates, e.g. using an azimuth value azi and an elevation value ele) and an object feature information The object feature information may, for example, be an information indicating whether the object is small or extended, e.g. an object size value, or the object feature information may, for example, be an object distance information, which can be mapped onto a spread value (e.g. onto a spread angle information describing a spread in an azimuth direction, e.g. spreadAngleAzi, and/or onto a spread angle information describing a spread in an elevation direction, e.g. spreadAngleEle). However, other types of object feature information are also possible.

The object renderer is configured to obtain spread object loudspeaker gains (also designated as spread loudspeaker gains, or represented as a vector gOS) considering the object position information and the object feature information.

The object renderer is configured to obtain spread gains (e.g. object-to-supporting-points spread gains, e.g. g_spd), like, for example, elements of a vector g_spd, describing contributions of an audio object signal to a plurality of loudspeaker signals, or to a plurality of supporting point signals, using one or more polynomial functions having a degree which is smaller than or equal to three, e.g. one or more parabolic functions or polynomial functions of degree three, (e.g. parable*((diffCLKDir+(n−1)*Spread.openAngle).\hat{ }2)+1 or parable*((diffAntiCLKDir+(n−1)*Spread.openAngle).\hat{ }2)+1) which, for example, map an angle difference (e.g. diffCLKDir+(n−1)*Spread.openAngle or diffAntiCLKDir+(n−1)*Spread.openAngle) between an object position and a supporting point position onto a spread gain value contribution (e.g. aziGain(naz) or eleGain(nel)).

The object renderer is configured to obtain the spread object loudspeaker gains using spread gains (g_spd), which are based on the spread gain contributions.

This embodiment is based on the finding that polynomial functions having a degree which is smaller than or equal to 2 are particularly well-suited for obtaining object spread gains on the basis of angle differences between object positions and supporting point positions. It has been recognized that polynomial functions having a degree which is smaller than or equal to 3 can be evaluated with moderate computational effort and are well-usable in situations in which computational resources are limited. However, it has been found that such polynomial functions still well-approximate a characteristic which is needed to obtain object spread gains that provide for a good hearing impression of a spread audio object. In particular, it has been found that polynomial functions having a degree which is smaller than or equal to 3 can be evaluated much more easily than other functions, like, for example, exponential functions, that need a very high computational effort or large lookup tables. Thus, the audio object renderer can be implemented with particularly small computational effort.

Moreover, it should be noted that the object feature information can be used to adjust the determination of the spread object loudspeaker gains. For example, the object feature information can determine a spread width. For example, the object feature information may be an information indicating whether an object is small or extended, e.g., comprise an object size value, or the object feature information may, for example, comprise an object distance information, which can be mapped onto a spread value, e.g., onto a spread angle information describing a spread in an azimuth direction, e.g., spreadAngleAzi, and/or onto a spread angle information describing a spread in an elevation direction, e.g., spreadAngleEle. In other words, it should be noted that the object feature information typically allows to determine or estimate an extension of an audio object. For example, the object feature information may indicate a type of object, wherein this type of object may imply parameters for the determination of the spread object loudspeaker gains (for example, a spread parameter). For example, the object feature information may allow for a distinction between comparatively small objects and comparatively large objects. Alternatively, or in addition, the object feature information may allow for a distinction between near objects and far objects, which may also imply one or more parameters for the determination of the spread object loudspeaker gains.

To conclude, the audio object renderer may derive one or more parameters for the determination of the spread object loudspeaker gains from the object feature information. Accordingly, the object feature information allows to properly adjust the derivation of the spread object loudspeaker gains, such that a good hearing impression can be achieved.

To conclude, by using one or more polynomial functions having a degree which is smaller than or equal to 3, and parameters of which may, for example, be dependent on the object feature information, it is possible to efficiently determine the spread object loudspeaker gains, keeping a computational effort reasonable small.

However, it should be noted that the above mentioned approach could optionally be applied in a more general form. In particular, it would not be needed to perform an object spread. For example, if supporting points are rendered in advance, in order to render object characteristics (or object properties or object features) by applying a weighting curve to the supporting points, this weighting curve could, for example, be implemented by a polynomial of degree three for efficiency reasons.

An embodiment according to the invention creates an audio object renderer for determining loudspeaker gains (e.g. combined loudspeaker gains) describing gains for an inclusion of one or more audio object signals into a plurality of loudspeaker signals on the basis of an object position information (e.g. azimuth (azi), elevation (ele))(which may, for example, be provided in spherical coordinates, e.g. using an azimuth value azi and an elevation value ele) and a spread information (e.g. a spread angle information describing a spread in an azimuth direction, e.g. spreadAngleAzi, and/or a spread angle information describing a spread in an elevation direction, e.g. spreadAngleEle).

The object renderer is configured to obtain spread object loudspeaker gains (also designated as spread loudspeaker gains, or represented as a vector gOS) considering the object position information and the spread information.

The object renderer is configured to obtain spread gains (e.g. object-to-supporting-points spread gains, e.g. g_spd), for example, spread gain values (e.g. elements of a vector g_spd), describing contributions of an audio object signal to a plurality of loudspeaker signals, or to a plurality of supporting point signals, using one or more polynomial functions having a degree which is smaller than or equal to three, e.g. parabolic functions or polynomial functions of degree three (e.g. parable*((diffCLKDir+(n−1)*Spread.openAngle).\hat{ }2)+1 or parable*((diffAntiCLKDir+(n−1)*Spread.openAngle).\hat{ }2)+1) which map an angle difference (e.g. diffCLKDir+(n−1)*Spread.openAngle or diffAntiCLKDir+(n−1)*Spread.openAngle) between an object position and a supporting point position onto a spread gain value contribution (e.g. aziGain(naz) or eleGain(nel)).

The object renderer is configured to obtain the spread object loudspeaker gains using spread gains [g_spd], which are based on the spread gain contributions.

Generally speaking, the function, which is used (e.g. the polynomial function) should advantageously (but not necessarily) have (at least approximately) a curve shape of the point source panning (in the present example: VBAP). The function does not necessarily need to be a parable. The idea is that spread components are panned between the supporting points in the same manner (like an object is normally panned between two speakers, e.g. using VBAP).

This audio object renderer is based on the same consideration as the above-mentioned audio object renderer. However, instead of object feature information, a spread information is evaluated, which directly describes how an object should be spread out. For example, the spread information may be spread angle information describing a spread in an azimuth direction and/or a spread in an elevation direction. Alternatively, the spread information may also be solid angle information, or may specify the size of the object in any other form (e.g., using an absolute size information and/or distance information, or the like). Accordingly, it is possible to obtain the spread object loudspeaker gains in a computationally efficient manner, wherein the spread information may, for example, be used to adjust parameters of the one or more polynomial functions (for example, a width of a parable used for obtaining the spread gains). Thus, a computation can easily be adjusted to the actual spread, as indicated by the spread information, and the computations can be done in an efficient manner.

In an embodiment of the audio object renderer mentioned before, a width of the one or more polynomial functions (e.g. of a parabolic function, which may be determined, for example, by a scaling value aziParable or a scaling value eleParable) is determined by the spread information or by the object feature information (wherein the audio object renderer may, for example, be configured to adapt the width of the one or more polynomial functions or of the parabolic function to spread widths associated with different audio objects).

It has been found that a width of a polynomial function (e.g., of a parabolic function) can be adjusted easily, since a polynomial function can easily be parametrized. However, the evaluation of a parabolic function (e.g. of a polynomial function) comprising one or more parameters is typically possible without excessive computational effort. Furthermore, by adjusting one or more parameters of the parabolic function in dependence on the spread information or in dependence on the object feature information, the spreading width can be adjusted very smoothly, resulting in a very good perceptional impression.

In an embodiment of the audio object renderer mentioned before, the object renderer is configured to obtain a spread gain value (e.g. a value of the vector g_spd) using a first polynomial function (e.g. a polynomial function having a degree which is smaller than or equal to three, e.g. a parabolic function), which maps an azimuth angle difference between an object position and a supporting point position onto a first spread gain value contribution (e.g. aziGain(naz)), and using a second polynomial function (e.g. a polynomial function having a degree which is smaller than or equal to three, e.g. a parabolic function), which maps an elevation angle difference between an object position and a supporting point position onto a second spread gain value contribution (e.g. eleGain(nel)).

This concept is based on the idea that a two-dimensional spreading function, which may, for example, depend both on an elevation angle difference between an audio object position and a spread supporting point position and on an azimuth angle difference between the audio object position and the spread supporting point position can be determined, in an efficient manner, using a combination (for example, a multiplication) of two spreading functions, one of which is applied to an azimuth angle difference and one of which is applied to an elevation angle difference. In other words, it has been found that a good spreading result can be achieved if two separate, parabolic spreading functions are applied to an azimuth angle difference and to an elevation angle difference, wherein the results are multiplied. In particular, it has been found that such a type of two-dimensional spreading results in a reasonably good hearing impression while keeping the computational effort small. In particular, a separate evaluation of two spreading functions is typically computationally significantly less demanding than an evaluation of a joint two-dimensional function, while providing a good hearing impression.

In an embodiment of the audio object renderer mentioned before, the audio object render is configured to combine (e.g. multiplicatively combine) the first spread gain contribution (e.g. aziGain(naz)) and the second spread gain contribution (e.g. eleGain(nel)), to obtain a spread gain value (e.g. a value of the vector g_spd).

By combining the spread gain contributions, which may, for example, be performed using a multiplication, a two-dimensional spreading can be achieved, which well-approximates the two-dimensional spreading according to the spreading function shown, for example, in FIG. 3. Worded differently, it has been found that multiplying two spread gain contributions, which are obtained on the basis of two polynomial functions, results in a two-dimensional spreading characteristic that provides a reasonably good hearing impression.

In an embodiment of the audio object renderer mentioned before, the object renderer is configured to compute, for a given object position (e.g. defined by an azimuth value azi and an elevation value ele) and for a given spread (e.g. defined by spreadAngleAzi or spreadAngleEle)
a set of azimuth gain values (e.g. aziGain) describing contributions to the spread gains for a plurality of azimuth values associated with supporting point positions or loudspeaker azimuth indices or supporting point azimuth indices (e.g. naz)(e.g. using a polynomial function having a degree which is smaller than or equal to three, or a parabolic function, a width of which is adapted to an object spread width in an azimuth direction), and/or
a set of elevation gain values (e.g. eleGain) describing contributions to the spread gains for a plurality of elevation values associated with supporting point positions or loudspeaker elevation indices or supporting point elevation indices (e.g. nel or naz)(e.g. using a polynomial function having a degree which is smaller than or equal to three, or a parabolic function, a width of which is adapted to an object spread width in an elevation direction),
   and to derive the spread gains using the set of azimuth gain values (aziGain(naz)) and/or using the set of elevation gain values (eleGain(nel)).

By determining a set of azimuth gain values associated with a plurality of supporting point positions and/or a plurality of elevation gain values associated with supporting point positions, a spreading characteristic in one or two planes can be determined, and the spread gains can be derived from this spreading characteristic in one or two planes. In the advantageous case that both a set of azimuth gain values associated with supporting point positions and a set of elevation gain values associated with supporting point positions are determined, the spread gains may, for example, easily be obtained using a multiplication of a pair of elements (of the sets) associated with a respective azimuth angle and a respective elevation angle of a supporting point under consideration. Accordingly, the polynomial functions only need to be evaluated for one set of supporting point positions having the same azimuth angle and different elevation angles, and for one set of supporting point positions having the same elevation angle and different azimuth angles, and the spread gains can then be derived (for example, for all supporting points) using computationally simple multiplications of appropriate elements of the set of azimuth gain values and of the set of elevation gain values. Thus, a high degree of computational efficiency can be reached.

In an embodiment of the audio object renderer mentioned before, the audio object renderer is configured to combine (e.g. using a multiplication) an element (e.g. aziGain(naz)) of the set of azimuth gain values (e.g. aziGain) associated with a currently considered loudspeaker or a currently considered supporting point (e.g. designated with objNo and having associated values naz and nel) with an element (e.g. eleGain(nel)) of the set of elevation gain values (e.g. eleGain) associated with the currently considered loudspeaker or the currently considered supporting point, in order to obtain spread gain values (e.g. g_spd(objNo), represented by a vector g_spd) associated with a plurality of different loudspeakers or with a plurality of different supporting points (e.g. designated by different values of objNo).

Thus, by determining spread gain values associated with different supporting points using multiplications of a respective element of the set of azimuth gain values and of a respective element of the set of elevation gain values (for example, elements associated with an azimuth angle and an elevation angle of the respective supporting point), the spread values associated with the different supporting points can be obtained in a computationally efficient manner. A particularly high efficiency can be reached, if a plurality of supporting points comprise same azimuth angle values, and if a plurality of supporting points comprise same elevation angle values. In this case, the number of elements of the set of azimuth gain values and the number of elements of the set of elevation gain values can be kept reasonably small, and elements of the set of azimuth gains values and elements of the set of elevation gain values can be reused for the determination of spread values associated with a plurality of supporting points. In other words, such a concept is particularly efficient in combination with a uniform spacing (in terms of azimuth angle and elevation angle) of the supporting points.

In an embodiment of the audio object renderer mentioned before, the audio object renderer is configured to compute, for a given object position (e.g. defined by an azimuth value azi and an elevation value ele) and for a given spread (e.g. defined by spreadAngleAzi or spreadAngleEle)
a first set of azimuth gain values (e.g. aziGain) describing contributions to the spread gains for a plurality of azimuth values associated with supporting point positions or loudspeaker azimuth indices or supporting point azimuth indices (e.g. naz)(e.g. using a polynomial function having a degree which is smaller than or equal to three or using a parabolic function a width of which is adapted to an object spread width in an azimuth direction), which is associated with elevation values in an original elevation value range (e.g. −90 degree to +90 degree, which indicates no crossing of a pole of the spherical coordinate system], and
a second set of azimuth gain values (e.g. aziGainExtd) describing contributions to the spread gains for a plurality of azimuth values associated with supporting point positions or loudspeaker azimuth indices or supporting point azimuth indices (e.g. naz)(e.g. using a polynomial function having a degree which is smaller than or equal to three or using a parabolic function a width of which is adapted to an object spread width in an azimuth direction), which is associated with elevation values in an extended elevation value range (e.g. −180 degree to −90 degree and +90 degree to +180 degree) which indicates a crossing of a pole of the spherical coordinate system, and
   to derive the spread gains using the set of azimuth gain values (aziGain(naz)) and/or using a set of elevation gain values (eleGain(nel)) (or using the second set of azimuth gain values).

By computing two sets of azimuth gain values, one for an original (or basic) elevation value range, and one for an extended elevation value range, spread gains for a spreading of an audio object over the head of a listener (or below a listener) can be computed in a particularly efficient manner. In particular, it has been found that the set of azimuth gain values can be used for derivation of the spread gains in an efficient manner, for example, using a predefined combination mapping. On the other hand, the separate sets of elevation gain values can also be computed in an efficient manner, since elevation values in the extended elevation value range can easily be derived from elevation values in the original elevation value range using an addition or subtraction (for example) without the distinction of multiple cases and without a change of an azimuth value. For example, when spreading an audio object over the head of a user, the spreading over the head of the user can simply be computed by using elevation values larger than 90 degrees. Accordingly, an object having a given azimuth angle (for example, an azimuth angle which lies in a range between −90 degree and +90 degree) and positive elevation angle between 0 degrees and 90 degrees, can easily be extended over the head of a user while maintaining the azimuth angle (within the range between −90 degrees and +90 degrees) using an elevation angle which is larger than 90 degrees. Accordingly, azimuth gain values associated with elevation values in the extended elevation value range (in this example, between +90 degrees and +180 degrees) can be obtained as an intermediate quantity, and can later be mapped back, for example, towards supporting points or towards a coordinate system using elevation angles only within the original elevation range. The presence of the first set of azimuth gain values and of the second azimuth gain values allows for an efficient derivation of spread values, since the second set of azimuth gain values are adapted to be combined with elevation gain values in the extended elevation value range.

In an embodiment of the audio object renderer mentioned before, the audio object renderer is configured to compute, for a given object position (e.g. defined by an azimuth value azi and an elevation value ele) and for a given spread (e.g. defined by spreadAngleAzi or spreadAngleEle)
a first set of elevation gain values (e.g. eleGain) describing contributions to the spread gains for a plurality of elevation values associated with supporting point positions or loudspeaker azimuth indices or supporting point elevation indices (e.g. nel)(e.g. using a polynomial function having a degree which is smaller than or equal to three or using a parabolic function, a width of which is adapted to an object spread width in an azimuth direction), which is associated with elevation values in an original elevation value range (e.g. −90 degree to +90 degree) which indicates no crossing of a pole of the spherical coordinate system], and
a second set of elevation gain values (e.g. eleGainExtd) describing contributions to the spread gains for a plurality of elevation values associated with supporting point positions or loudspeaker elevation indices or supporting point elevation indices (e.g. nel)(e.g. using a polynomial function having a degree which is smaller than or equal to three or using a parabolic function, a width of which is adapted to an object spread width in an azimuth direction), which is associated with elevation values in an extended elevation value range (e.g. −180 degree to −90 degree and +90 degree to +180 degree) which indicates a crossing of a pole of the spherical coordinate system, and
   and to derive the spread gains using the set of azimuth gain values (aziGain(naz)) and using a set of elevation gain values (eleGain(nel)) (or using the first set of azimuth gain values, the second set of azimuth gain values, the first set of elevation gain value and the second set of elevation gain values).

This embodiment is based on similar considerations like the embodiment computing azimuth gain values. In particular, the presence of a first set of elevation gain values and of a second set of elevation gain values allows for a simple, computationally efficient handling of cases in which an object is spread over the head of a listener. In particular, it has been found to be much easier to use extended elevation values (for example, larger than +90 degrees) in such a case when compared to the immediate modification of the azimuth value and a “transformation” of the elevation value.

As an example only, if the object position comprises an elevation of +80 degrees, it is much easier to assume, for the purpose of further computations and for the purpose of an evaluation of the parabolic functions, that the supporting point is at an elevation angle of, for example, 135 degree, because it can then be said that the elevation angle difference between the audio object and the supporting point is 55 degrees. If, in contrast, the supporting point at 135 degree would be referenced as a supporting point at an elevation of 45 degree, it would not be easily possible to compute a correct elevation angle difference between the position of the audio object and the supporting point position.

To summarize, usage of such an extended elevation range has been found very efficient, since it avoids a large number of case distinctions in the computations and facilitates the evaluation of the polynomial functions. Moreover, it has been found that the derivation of the spread gains it is possible, for example, using the first set of azimuth gain values, the second set of azimuth gain values, the first set of elevation gain values and the second set of elevation gain values. In this case, for example, the entries of the first set of azimuth gain values and the entries of the first set of elevation gain values can be combined, and the entries of the second set of azimuth gain values and the entries of the second set of elevation gain values can be combined efficiently, to thereby derive the spread values.

In an embodiment of the audio object renderer mentioned before, the audio object renderer is configured to pre-compute supporting point panning gains (e.g. Spread.gainsSSP) for panning audio signals associated to a plurality of supporting points onto a plurality of loudspeakers during an initialization (based on a knowledge of positions of the supporting points and positions of the loudspeakers) using a panning (e.g. vector-based amplitude panning).

The audio object renderer is configured to obtain object-to-supporting-point spread gains (e.g. g_spd or spread gain values, e.g. elements of a vector g_spd) describing contributions of an audio object signal to a plurality of supporting point signals using the polynomial function having a degree which is smaller than or equal to three (e.g. using a parabolic function).

The audio object renderer is configured to combine (e.g. multiply) the object-to-supporting-point spread gains and the supporting point panning gains, in order to obtain the spread object loudspeaker gains.

It has been found that separately computing supporting point panning gains and object-to-supporting point spreading gains, and then combining the object-to-supporting point spreading gains and the support point panning gains brings along a particularly high computational efficiency, in particular if there is more than one audio object. Since the supporting points are typically unchanged for a handling of multiple audio objects, the supporting point panning gains only need to be computed once, which can be done in a preparatory step. In contrast, the object-to-supporting point spread gains are typically dependent on the object position and therefore need to be computed individually for each audio object.

Thus, by re-using the supporting point panning gains for multiple objects, the computational efficiency can be improved, without degrading an achievable audio quality. Moreover, the usage of supporting points is also particularly efficient, since a spatial arrangement of the supporting points can be adjusted freely, focusing on computational efficiency without being constrained by the actual speaker positions or the actual speaker set up. Thus, the supporting points can, for example, be chosen in a uniformly distributed manner (for example, having a uniform azimuth spacing and a uniform elevation spacing) which significantly facilitates the determination of the object-to-supporting point spread gains. Thus, it can be said that the usage of spread supporting points as an intermediate spreading target actually helps to improve the efficiency, because the first spreading step can be made independent from the actual speaker arrangement, and since the second spreading step (from spread supporting points to speaker signals) only needs to be computed once, even in the presence of plurality of audio objects. Thus, the process is highly efficient.

In an embodiment of the audio object renderer mentioned before, the one or more polynomial functions having a degree which is smaller than or equal to three are parabolic functions which provide a return value p according to

p=max(0,c1*anglediff²+c2),

wherein c1 is a parameter determining a width of the parabolic function, wherein c2 is a predetermined value, wherein angeldiff is an angle difference for which the parabolic function is evaluated, and wherein max(.,.) is a maximum value operator returning a maximum value of its operands.

It has been found that such a polynomial function, which is restricted to non-negative values (e.g. using the max-operation) well-approximates a desired spread characteristic and can be evaluated with little computational effort. Thus, such a polynomial function has been found to be very good for determining the spread values.

An embodiment according to the invention creates a method for determining loudspeaker gains (e.g. combined loudspeaker gains) describing gains for an inclusion of one or more audio object signals into a plurality of loudspeaker signals on the basis of an object position information (e.g. azimuth (azi), elevation (ele))(which may, for example, be provided in spherical coordinates, e.g. using an azimuth value azi and an elevation value ele) and an object feature information (e.g. a spread angle information describing a spread in an azimuth direction, e.g. spreadAngleAzi, and/or a spread angle information describing a spread in an elevation direction, e.g. spreadAngleEle).

The method comprises obtaining spread object loudspeaker gains (also designated as spread loudspeaker gains, or represented as a vector gOS) considering the object position information and the object feature information.

The method comprises obtaining spread gains (e.g. object-to-supporting-points spread gains, e.g. g_spd), e.g. spread gain values, e.g. elements of a vector g_spd, describing contributions of an audio object signal to a plurality of loudspeaker signals, or to a plurality of supporting point signals, using one or more polynomial functions having a degree which is smaller than or equal to three, e.g. a parabolic functions or polynomial functions of degree three (e.g. parable*((diffCLKDir+(n−1)*Spread.openAngle).\hat{ }2)+1 or parable*((diffAntiCLKDir+(n−1)*Spread.openAngle).\hat{ }2)+1) which map an angle difference (e.g. diffCLKDir+(n−1)*Spread.openAngle or diffAntiCLKDir+(n−1)*Spread.openAngle) between an object position and a supporting point position onto a spread gain value contribution (e.g. aziGain(naz) or eleGain(nel)).

The method comprises obtaining the spread object loudspeaker gains using spread gains (e.g. g_spd), which are based on the spread gain contributions, or using the spread gains (e.g. g_spd) as the spread object loudspeaker gains.

This method is based on the same considerations as the above-mentioned corresponding apparatus. Moreover, the method can optionally be supplemented by any of the features, functionalities and the details described with respect to the above-mentioned corresponding apparatus, both individually and taken in combination.

An embodiment creates a method for determining loudspeaker gains (e.g. combined loudspeaker gains) describing gains for an inclusion of one or more audio object signals into a plurality of loudspeaker signals on the basis of an object position information (e.g. azimuth (azi), elevation (ele))(which may, for example, be provided in spherical coordinates, e.g. using an azimuth value azi and an elevation value ele) and a spread information (e.g. a spread angle information describing a spread in an azimuth direction, e.g. spreadAngleAzi, and/or a spread angle information describing a spread in an elevation direction, e.g. spreadAngleEle).

The method comprises obtaining spread object loudspeaker gains (also designated as spread loudspeaker gains, or represented as a vector gOS) considering the object position information and the spread information.

The method comprises obtaining spread gains (e.g. object-to-supporting-points spread gains, e.g. g_spd), e.g. spread gain values, e.g. elements of a vector g_spd, describing contributions of an audio object signal to a plurality of loudspeaker signals, or to a plurality of supporting point signals, using one or more polynomial functions having a degree which is smaller than or equal to three, e.g. parabolic functions or polynomial functions of degree three (e.g. parable*((diffCLKDir+(n−1)*Spread.openAngle).\hat{ }2)+1 or parable*((diffAntiCLKDir+(n−1)*Spread.openAngle).\hat{ }2)+1) which map an angle difference (e.g. diffCLKDir+(n−1)*Spread.openAngle or diffAntiCLKDir+(n−1)*Spread.openAngle) between an object position and a supporting point position onto a spread gain value contribution (e.g. aziGain(naz) or eleGain(nel)).

The method comprises obtaining the spread object loudspeaker gains using spread gains (e.g. g_spd), which are based on the spread gain contributions, or using the spread gains (e.g. g_spd) as the spread object loudspeaker gains.

This method is based on the same considerations as the above-mentioned corresponding apparatus. Moreover, the method can optionally be supplemented by any of the features, functionalities and the details described with respect to the above-mentioned corresponding apparatus, both individually and taken in combination.

An embodiment according to the invention creates a computer program for performing one of the methods mentioned before when the computer program runs on a computer.

The computer program can be supplemented by any of the features, functionalities and the details described herein, both individually and taken in combination.

### BRIEF DESCRIPTION OF THE DRAWINGS

Embodiments of the present invention will be detailed subsequently referring to the appended drawings, in which:

FIG. 1 shows a representation of different object spread configurations;

FIG. 2 shows a signal flowchart for object spread realization for asymmetrical and/or 2D loudspeaker setups;

FIG. 3 shows a graphic representation of different spread gain functions;

FIG. 4 shows a graphic representation of one-dimensional gain curves for different spread angles;

FIG. 5 shows a signal flow chart for rendering spread gains;

FIG. 6 shows a graphic representation of a SSP grid with a resolution of 45 degrees;

FIG. 7 shows a comparison of the shapes of a VBAP panning core and a stretched and flipped parable;

FIG. 8 shows a MATLAB code example of a function spread_pannSSP;

FIG. 9 shows a MATLAB code example of a function spread_calculateGains;

FIG. 10 shows a MATLAB code example of a function calculateLayerGains;

FIG. 11 shows a matlab code example of a function calculateSSPGains;

FIG. 12 shows a block schematic diagram of an audio object renderer, according to an embodiment of the present invention;

FIG. 13 shows a block schematic diagram of an audio object renderer, according to an embodiment of the present invention;

FIG. 14 shows a flowchart of a method for determining loudspeaker gains, according to an embodiment of the present invention; and

FIG. 15 shows a flowchart of a method for determining loudspeaker gains, according to an embodiment of the invention.

### DETAILED DESCRIPTION OF THE INVENTION

### 1. Discussion of Some Embodiments

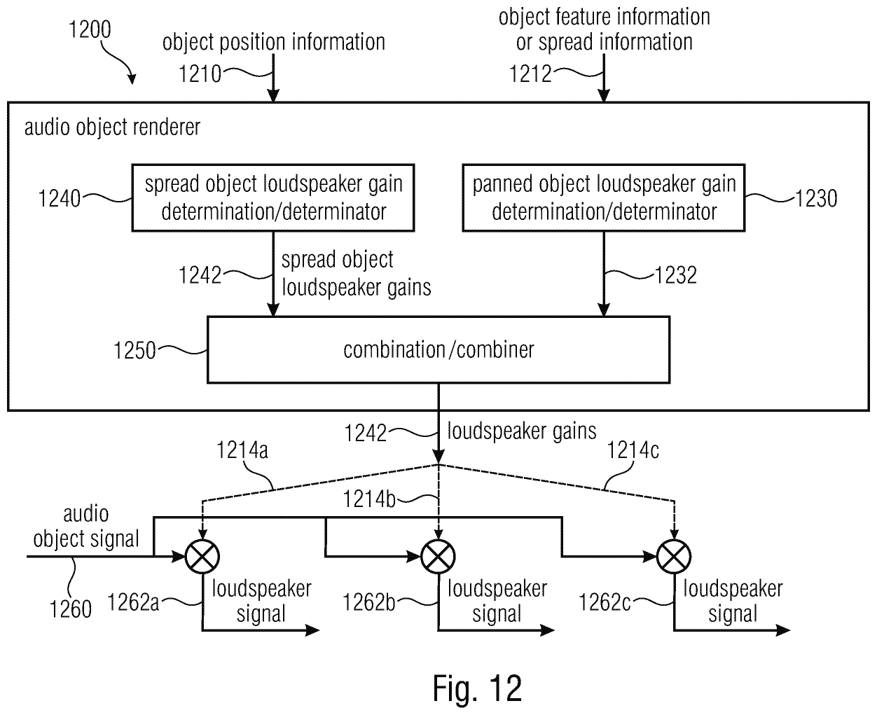

### 1. A. Audio Object Renderer According to FIG. 12

FIG. 12 shows a block schematic diagram of an audio object renderer 1200, according to an embodiment of the present invention.

The audio object renderer 1200 is configured to receive an object position information 1210 and an object feature information 1212. Moreover, the audio object renderer 1200 is configured to provide loudspeaker gains 1214 (e.g., combined loudspeaker gains or resulting loudspeaker gain) describing gains for an inclusion of one or more audio object signals into a plurality of loudspeaker signals.

The object position information 1210 may, for example, comprise an object azimuth information (e.g., azi) and an object elevation information (e.g., ele). For example, the object position information may be provided in spherical coordinates, e.g., using an azimuth value azi and an elevation value ele. Moreover, the object feature information or spread information 1212 may, for example, describe characteristics of an audio object and make an indication how the object should be spread. The object feature information may, for example, be an information indicating whether the object is small or extended, e.g., an object size value. The object feature information may, for example, comprise an object distance information, which can be mapped onto a spread value e.g., onto a spread angle information describing a spread in an azimuth direction, e.g., spreadAngleAzi, and/or onto a spread angle information describing a spread in an elevation direction, e.g., spreadAngleEle. However, different types of object feature information are also possible. Alternatively, the audio object renderer may directly receive a spread information which describes, for example, the spread of the audio object in the azimuth direction and/or in the elevation direction.

The audio object renderer 1200 comprises a panned object loudspeaker gain determination 1230, which may be configured to obtain panned object loudspeaker gains 1232 (for example, also designed as “object loudspeaker gains”, or represented by a vector g) using a point source panning of the audio object. In the point source panning, the audio object may, for example, be considered as a point source, wherein the spread information or object feature information 1212 is, for example, neglected, and wherein a signal of the audio object is associated to two or more loudspeakers in an environment of the object position of the audio object by an appropriate choice of the panned object loudspeaker gains 1232. In other words, the panned object loudspeaker gain determination 1230 may, for example, perform a point source panning of an audio object which considers the audio object as a point source, and may distribute the audio object signal to those loudspeakers (only) which are closest to the audio object. However, no contributions of the audio object signal may be assigned to loudspeakers which are further away from the audio object by the point source panning. However, the panned object loudspeaker gain determination 1230 may use any point source panning concept.

Moreover, the audio object renderer 1200 may comprise a spread object loudspeaker gain determination 1240 which provides spread object loudspeaker gains 1242 (also designated, for example, as spread loudspeaker gains, and represented, for example, as a vector gOS) considering the object position information 1210 and the object feature information or spread information 1212. For example, the spread object loudspeaker gain determination 1240 may determine loudspeaker gains which consider a spreading of the audio object, for example, in an azimuth direction and an elevation direction. Accordingly, the spread object loudspeaker gains may be non-zero over a wide range, because an audio object under consideration is assumed to have a significant extension and because, typically, a smooth and steady decay of the spread object loudspeaker gains with increasing distance from a center position of the object is assumed (and implemented) in the spreading.

Moreover, the audio object renderer 1200 comprises a combination or combiner 1250 which combines the panned object loudspeaker gains 1232 (e.g., g) and the spread object loudspeaker gains (e.g., gOS) in such a manner, that there is a contribution of the panned object loudspeaker gains (e.g., independent from the object feature information or spread information 1212) in order to obtain the combined loudspeaker gains.

Accordingly, it can be said that the audio object renderer 1200 provides combined loudspeaker gains 1214 on the basis of both a point source panning of an audio object signal and a spreading of the audio object signal. For example, there is a contribution of the panned object loudspeaker gains in the combined loudspeaker gains 1214, which ensures that an object can be reasonably localized, even if the audio object is spread over a comparatively wide range.

Moreover, it should be noted that the concept described here can be implemented with particularly high computational efficiency, as will be described in the following.

Moreover, it should be noted that FIG. 12 also shows how the combined loudspeaker gains 1214 may be used in the further processing. For example, there may be provided loudspeaker gains 1214a, 1214b, 1214c associated with different loudspeakers in a loudspeaker setup. An audio object signal 1260, which is an audio signal associated with an audio object under consideration, may be scaled with a loudspeaker gain 1214a associated with a first loudspeaker, to obtain a first loudspeaker signal 1262a, and the audio object signal 1260 may be scaled with a loudspeaker gain 1214b associated with a second loudspeaker to obtain a second loudspeaker signal 1262b, and the audio object signal 1260 may be scaled with a third loudspeaker gain 1214c to obtain a third loudspeaker signal 1262c, and so on. The loudspeaker signals 1262a, 1262b, 1262c may naturally be combined with loudspeaker signals associated with other audio objects, to obtain actual loudspeaker signals.

Accordingly, loudspeaker signals may be obtained on the basis of the combined loudspeaker gains 1214, by which an audio object under consideration is represented both in a point-source-panned form and in a spread form, which has been found to provide a particularly good hearing impression.

Moreover, it should be noted that the audio object renderer 1200 can optionally be supplemented by any of the features, functionalities and the details described herein, both individually and taken in combination.

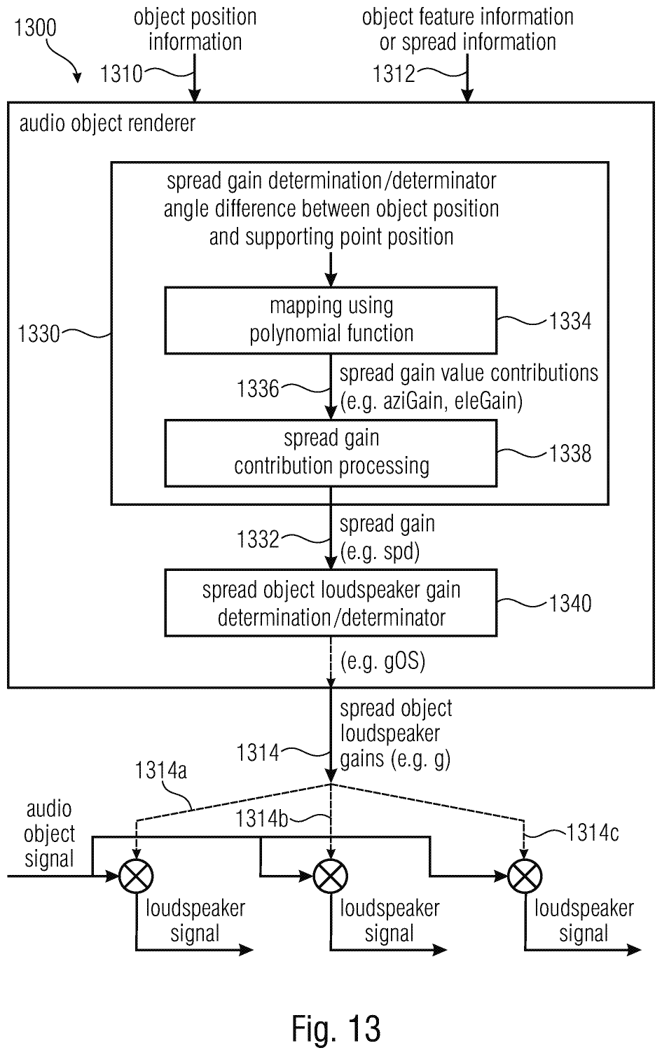

### 1.B. Audio Object Renderer According to FIG. 13

FIG. 13 shows a block schematic diagram of an audio object renderer 1300, according to an embodiment of the present invention. The audio object renderer 1300 is configured to receive an object position information 1310, which may, for example, correspond to the object position information 1210. Moreover, the audio object renderer 1300 is configured to receive an object feature information or spread information 1312, which may correspond to the object feature information or spread information 1212. Moreover, the audio object renderer 1300 provides (combined) loudspeaker gains 1314, which may correspond to the loudspeaker gains 1214, and which may be applied to an audio object signal in the same manner as the loudspeaker gains 1214a to 1214c. The audio object renderer is configured to obtain spread object loudspeaker gains (also designated as spread loudspeaker gains, or represented as a vector gOS) considering the object position information 1310 and the object feature information or spread information 1312.

The audio object renderer comprises a spread gain determination 1330, which is configured to obtain spread gains 1332, which may, for example, be object-to-supporting-point spread gains (e.g., g_spd). For example, the spread gain determination may be configured to determine elements of a vector g_spd, describing contributions of an audio object signal to a plurality of loudspeaker signals, or to a plurality of supporting point signals. In particular, the spread gain determination 1330 may use one or more polynomial functions having a degree which is smaller than or equal to 3 (e.g., one or more parabolic functions or polynomial functions of degree 3) to map one or more angle differences between an object position and one or more supporting point positions onto one or more spread gain value contributions (e.g., onto “layer gains”), which may be represented, for example, by aziGain, aziGainExtd, eleGain and eleGainExtd.

In other words, spread gain value contributions 1336 are obtained using a mapping 1334, which uses a polynomial function having a degree which is smaller than or equal to 3, wherein said mapping 1334 maps one or more angle differences between an object position and one or more supporting point positions onto the spread gain value contributions 1336. Moreover, the spread gain determination 1330 also comprises a spread gain contribution processing 1338, which provides the spread gains 1332 (e.g., spd) on the basis of the spread gain value contributions 1336. Moreover, the audio object renderer 1300 comprises a spread object loudspeaker gain determination 1340, which obtains the spread object loudspeaker gains 1340 on the basis of the spread gains 1332, wherein the latter are based on the spread gain contributions 1336.

Worded differently, spread gain value contributions are derived using the polynomial functions having a degree less than or equal to 3, and the spread gain value contributions 1336 are then mapped onto spread gains 1332, wherein said spread gains 1332 may, for example, describe how an audio object signal should be distributed to a plurality of supporting points. The spread object loudspeaker gain determination 1340 may map the spread gains (which are related to spread supporting points) onto the spread object loudspeaker gains, which corresponds to a mapping from supporting point positions to actual loudspeakers (and actual loudspeaker positions).

To further conclude, it should be noted that the derivation of the spread object loudspeaker gains uses a polynomial function, which can be evaluated using moderate computational complexity, rather than exponential or trigonometric functions which involve a comparatively high computational effort.

Accordingly, the spread gain value contributions 1336 allow the spread gains 1332 to be obtained in a very efficient manner. Also, it has been found that there is no significant loss in a hearing expression by using the polynomial functions having a degree smaller than or equal to 3.

However, it should be noted that the audio object renderer 1300 can optionally be supplemented by any of the features, functionalities and the details disclosed herein, both individually and taken in combination.

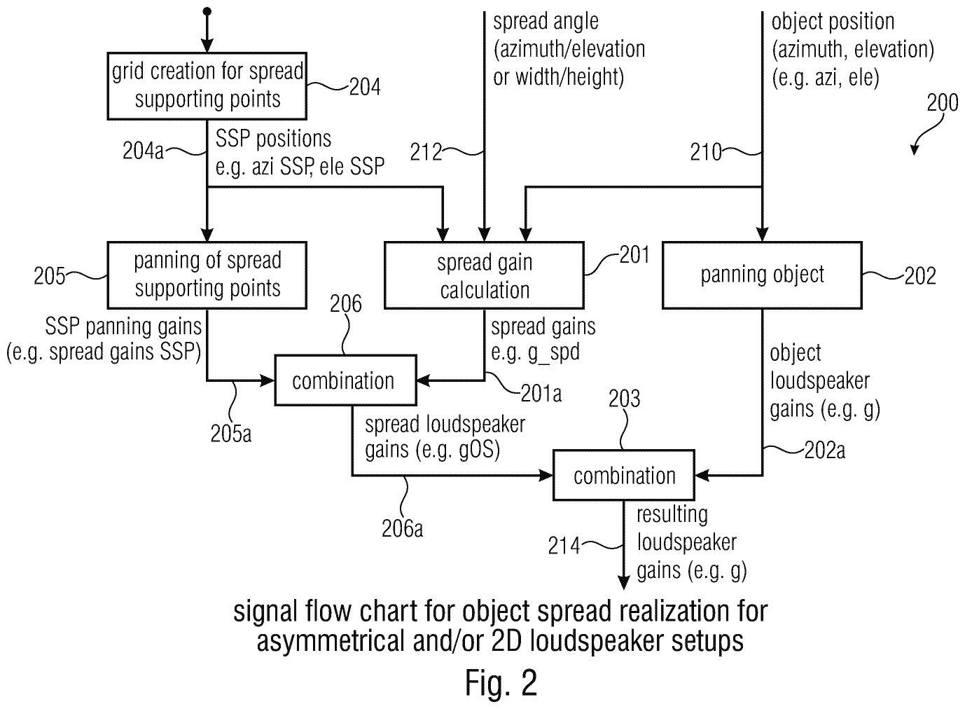

### 1.C. Loudspeaker Gain Computation According to FIG. 2

FIG. 2 shows a signal flowchart for an object spread realization for asymmetrical and/or 2D loudspeaker setup.

The signal flow shown in FIG. 2 may, for example, be implemented in the audio object renderers 1200, 1300, according to FIGS. 12 and 13.

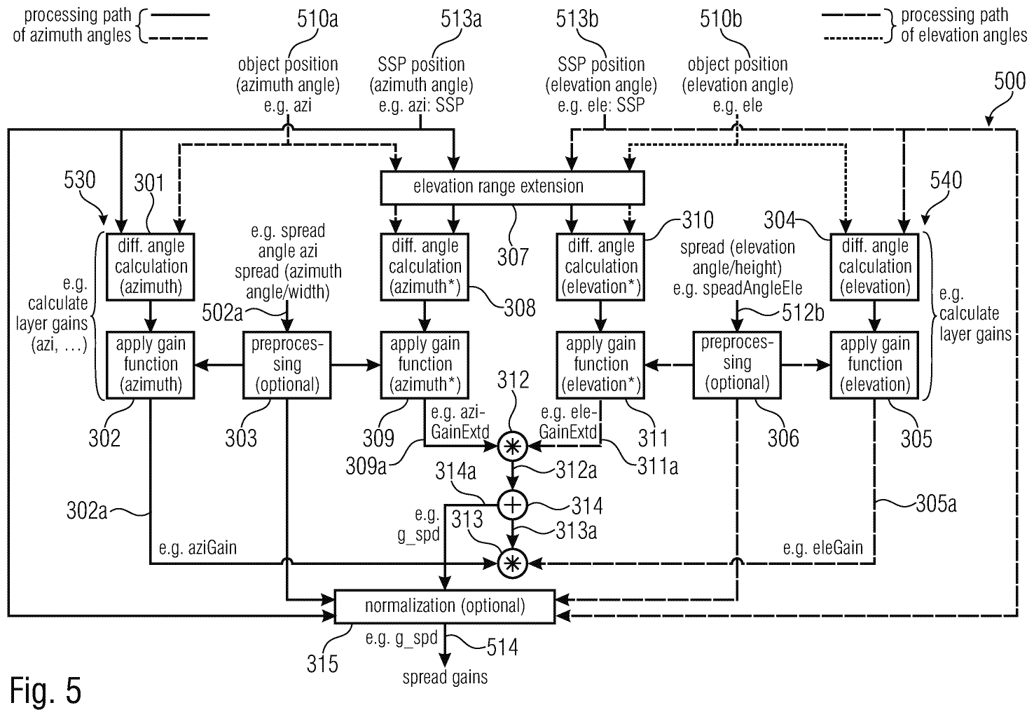

Moreover, concepts described taking reference to FIG. 2 may optionally also be included in the concept of FIG. 5, both individually and taken in combination.

The loudspeaker gain determination 200 according to FIG. 2 receives an object position information 210, which may, for example, correspond to the object position information 1210, 1310. The object position information may, for example, describe an object position in terms of an azimuth information (e.g., azi) and an elevation information (e.g., ele). The loudspeaker gain determination 200 also receives a spread angle information 212, which may, for example, correspond to the object feature information or spread information 1212, 1312. The spread angle information 212 may, for example, describe a spread angle in terms of an azimuth information and/or an elevation information, or in terms of a width information and/or a height information. Moreover, the loudspeaker gain determination 200 may, for example, provide resulting loudspeaker gains 214 which may, for example, correspond to the loudspeaker gains 1214, 1314.

The loudspeaker gain determination 200 comprises a grid creation 204 for spread supporting positions, which provides an information 204a describing spread supporting point positions. Moreover, the loudspeaker gain determination 200 may comprise a panning 205 of spread supporting points, which may, for example, provide spread supporting point panning gains 205a.

The supporting point position information 204a may, for example, describe positions of spread supporting points, which may, for example, be uniformly distributed on a sphere. For example, the spread supporting point positions described by the information 204a may be chosen independent from actual loudspeaker positions and may, for example, form a grid defined by a uniform azimuth spacing and elevation spacing.

The spread supporting point panning gains described by the information 205a may, for example, define how an audio object signal associated with a spread supporting point position is distributed to the actual loudspeakers or loudspeaker signals. Thus, the spread supporting point panning gains described by the information 205a may describe, for example, for all spread supporting points, a distribution of audio object signals associated with the spread supporting points to actual loudspeakers or loudspeaker signals.

It should be noted that grid creation 204 and the panning 205 may, for example, be computed only once, and may be re-used for a spreading of multiple audio objects, since the spread supporting points typically remain unchanged for a spreading of multiple audio objects.

The loudspeaker gain determination 200 also comprises a spread gain calculation 201, which considers the spread supporting point positions 204a, the object position information 210 and the spread angle information 212. The spread gain calculation 201 provides, on the basis thereof, spread gains 201a which may, for example, describe a spreading of audio object signals to a plurality of spread supporting points.

The loudspeaker gain determination 200 also comprises a combination 206 which combines the spread gains 201a with the spread supporting position panning gains 205a, to thereby obtain spread loudspeaker gains 206a (e.g., gOS). For example, the combination 206 may use a multiplication of the spread gains 201a and of the spread supporting point panning gains 205a. For example, the combination 206 may combine a mapping of audio object signals on to spread supporting points, which is described by the spread gains 201a, with a mapping of signals at (or associated with) spread supporting points onto actual loudspeaker signals, which is described by the spread supporting point panning gains 205a, and consequently provide a spread loudspeaker gains 206a such that the spread loudspeaker gains 206a describe contributions of an audio object signal of a currently considered audio object in actual loudspeaker signals (in the form of a weighting value to be applied to the audio object signal, to thereby derive the actual loudspeaker signals). However, it should be noted that the spread gain calculation 201 and the combination 206 is typically performed separately for each audio object to be spread (while the spread supporting point positions 204a and the spread supporting point panning gains 205a can be re-used without changes).

The loudspeaker gain determination 200 also comprises an object panning 202, which uses the object position information 210 to derive object loudspeaker gains or panned object loudspeaker gains 202a. The object panning 202 may, for example, perform a point-source panning of an audio object, wherein it may be determined into which actual loudspeaker signals contributions of an audio object signal of the audio object under consideration are taken over. Typically, only object loudspeaker gains (or panned object loudspeaker gains) for the loudspeakers directly adjacent to the object position are non-zero when using a point source panning.

The loudspeaker gain determination 200 also comprises a combination 203, in which the spread loudspeaker gains 206a and the panned object loudspeaker gains 202a are combined, to obtain the resulting loudspeaker gains 214 (which may, for example, be designated with g). The combination may, for example, comprise a summation or a weighted combination of the spread loudspeaker gains 206a and of the panned object loudspeaker gains 202a.

This concept allows for the provision of resulting loudspeaker gains 214, in which the panned object loudspeaker gains and the spread loudspeaker gains 206a are both included. It has been found that such a concept can be computed with high computational efficiency and provides a good quality audio perception.

It should be noted that the concept for the loudspeaker gain determination described with respect to FIG. 2 can optionally be supplemented by any of the features, functionalities and details described herein, both individually and taken in combination.

### 1.D. Spread Functions

In the following, some details regarding possible spread functions will be provided, which can be used in any of the audio object renderers described herein, and in any of the audio object rendering concepts described herein.

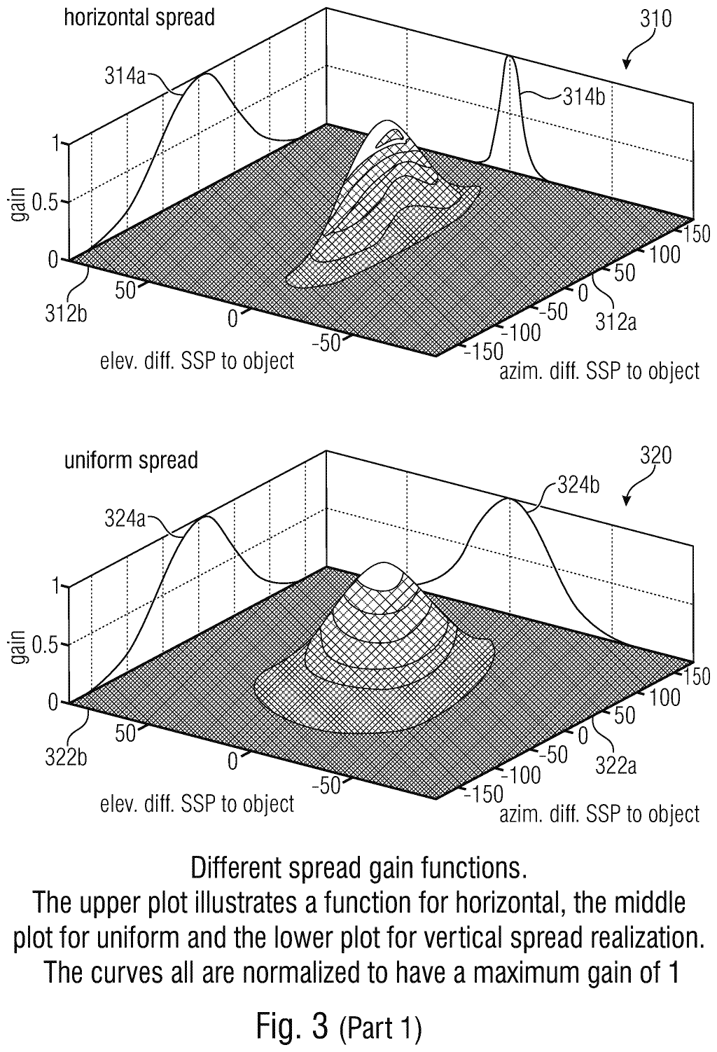

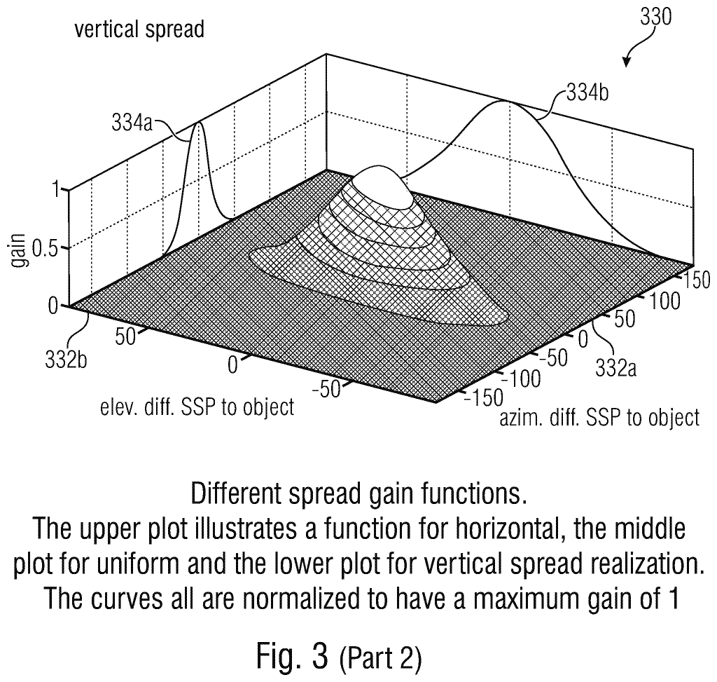

For example, FIG. 3 shows a graphic representation of different spread functions. It should be noted that the spread functions are typically defined relative to an object position. Accordingly, in the graphic representations 310, 320, 330, first axes 312a, 322a, 332a describe azimuth angle differences between currently considered spread supporting positions and object azimuth positions. Second axes 312b, 322b, 332b describe elevation angle differences between currently considered spread supporting point positions and object elevation positions.

A graphical representation 310 illustrates a horizontal spread (wherein a spread in an azimuth angle direction is larger than a spread in an elevation angle direction). A graphical representation 320 illustrates a uniform spread where a spread in an azimuth angle direction is equal to a spread in an elevation angle direction, and a graphical representation 330 illustrates a vertical spread, where a spread in an azimuth angle direction is smaller than a spread in an elevation angle direction.

The graphical representations illustrate a (relative) gain by which an audio object signal should be scaled (e.g. to obtain a signal at a spread supporting point) in dependence on the azimuth angle difference between the spread supporting point position and the azimuth object position, and in dependence on the elevation angle difference between the spread supporting point position and the object elevation position. For example, the gain can be obtained by a multiplication of a respective azimuth spread function 314a, 324a, 334a and a respective elevation spread function 314b, 324b, 334b. It should be noted that, herein, computationally efficient concepts to implement spread functions (or spread gain functions) which are very similar to the spread gain functions of FIG. 3, are described in detail. Moreover, it should be noted that the spread gain functions of FIG. 3 may, for example, be used or approximated in the audio object renderers 1200, 1300 described herein, or in the audio object rendering concept of FIGS. 2 and 5.

Moreover, it should be noted that further (optional) details regarding the spread gain functions will also be discussed herein.

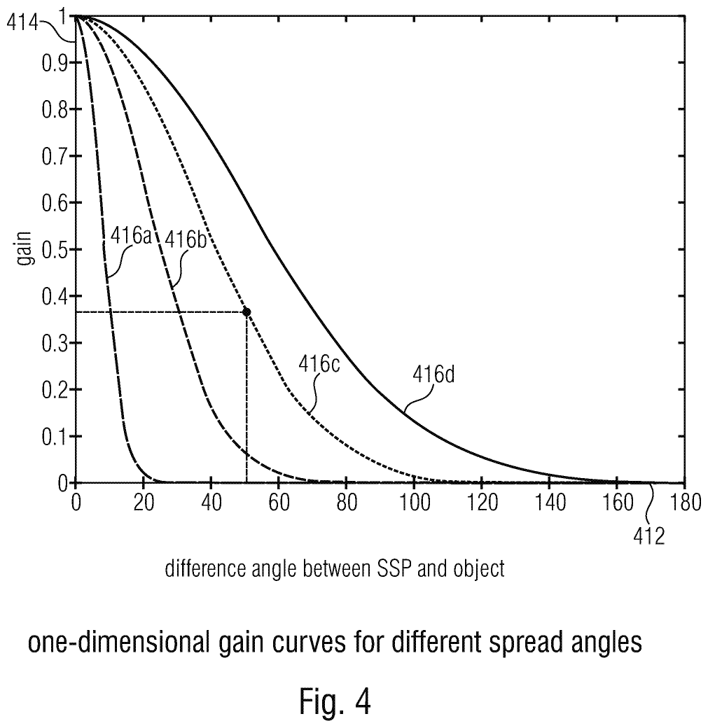

Moreover, FIG. 4 shows another graphic representation of a one-dimensional gain curve for different spread angles. It can be seen that the smaller the spread angle the steeper the graph. It should be noted that, in FIG. 4, an abscissa 412 describes a difference angle (for example, a difference azimuth angle or a difference elevation angle) between a spread supporting point and an object. An ordinate 414 describes a gain which is to be applied to derive a spread supporting point signal from an audio object signal in view of the difference angle (e.g. under the assumption of a one-dimensional spreading). Curves 416a, 416b, 416c, 416d representing the gain as a function of the difference angle, are associated with different spread angles. For example, the curve 416a is associated with a comparatively narrow spread angle, and the curve 416d is associated with a comparatively wide spread angle.

As an example, for a difference angle (azimuth or elevation) of 50 degrees between a spread supporting point (SSP) and the object, a gain value of 0.37 is determined from the gain curve 416c representing a rather strong spread value.

In other words, the gain curves shown in FIG. 4, or approximations thereof, may, for example, be used in the derivation of the spread gains 201a or in the derivation of the spread object loudspeaker gains 1242 or in the derivation of the spread gains 1332. Further details regarding the gain curves, and possible approximations thereof, are also described herein. Moreover, usage of the gain curves according to FIG. 4 will also be discussed in more detail herein.

### 1.E Spread Gain Determination According to FIG. 5

FIG. 5 shows a signal flow chart for rendering spread gains, according to an embodiment of the present invention. A processing path of the azimuth angles is covered by blue-colored lines or lines having a first hatching type and a second hatching type, and the elevation angles (or, more precisely, a processing path of the elevation angles) by orange-colored lines or lines having a third hatching type and a fourth hatching type.

The spread gain determination 500 receives, as input, an object position information, which comprises an azimuth object position information 510a and an elevation object position information 510b. The azimuth object position information 510a and the elevation object position information 510b may, for example, correspond to the object position information 210 described above. Moreover, the spread gain determination 500 also receives a spread-supporting point position information, which comprises an azimuth spread-supporting point position information 513a and an elevation spread supporting point position information 513b. The azimuth SSP position information 513a and the elevation SSP position information 513b may, for example, correspond to the SSP position information 204a which has been described above.

This spread gain determination 500 comprises an azimuth gain determination 530, which may, for example, comprise an azimuth difference angle calculation 301 and an azimuth gain function application 302. Moreover, the spread gain determination 500 also comprises an elevation gain determination 540, which may, for example, comprise an elevation difference angle calculation 304 and an elevation gain function application 305. For example, in the azimuth gain determination 530, one or more azimuth gain values (e.g. aziGain) may be determined on the basis of the azimuth object position information 510a and an azimuth SSP position information 513a. Moreover, an azimuth spread information 512a, or a preprocessed version thereof, may also be considered in the azimuth gain determination 530. For example, in the azimuth difference angle calculation 301, differences between the azimuth object position and one or more azimuth SSP positions may be computed, to obtain one or more angle differences, and gain values may be determined for these one or more angle differences in the azimuth gain function application 302. For example, the azimuth gain function application may evaluate a gain function (e.g. a gain function as illustrated in FIG. 3 and FIG. 4, or a polynomial or parabolic gain function as disclosed herein), for the one or more angle differences. Accordingly, one or more azimuth gain values are obtained, which are associated with spread support point positions and which are determined by a value of the azimuth gain function for the respective angle difference between the respective spread support point position (azimuth position) and the respective object position (azimuth position), wherein the azimuth spread information 502 is considered to adjust a width of the azimuth gain function.

A similar computation is performed by the elevation gain determination 540. The elevation gain determination 540 receives the elevation spread supporting point position information 513b and the elevation objection position information 510b and provides, on the basis thereof, one or more elevation gain values 305a. For example, one or more differences between an object position elevation angle and one or more spread supporting point position elevation angles may be computed by the difference angle calculation 304. An elevation gain function, a width of which may be determined by the elevation spread information 512b or by a preprocessed version thereof, may be applied (for example, may be evaluated for one or more of the difference angles determined by the difference angle calculation 304), in order to obtain the one or more elevation gain values 305a. For example, the elevation gain function described with reference to FIG. 3 or with reference to FIG. 4, or an approximation thereof (e.g., a polynomial gain function as disclosed herein) may be used in the elevation gain function application 305. The gain function may, for example, be evaluated for the one or more difference angles determined in the difference angle calculation 304, to obtain the one or more elevation gain values 305a.

For example, azimuth gain values 302a, which may, for example, be obtained for a given elevation and for multiple spread supporting point azimuth angles, may be combined, e.g. multiplicatively, with a plurality of elevation gain values 305a, which may be obtained, for example, for a given azimuth value and for a plurality of spread supporting point elevation values. The combination is designated with 313 and may be a multiplication, wherein different pairs of azimuth gain values 302a and elevation gain values 305a associated with different spread supporting points may be multiplied, to obtain contributions to gain values associated with the different spread supporting points.

The spread gain determination 500 also comprises, optionally, a handling of an extended elevation range. For example, the spread gain determination may (optionally) comprise an elevation range extension 307, which may, for example, adapt (or pre-process) azimuth object position information 510a and/or azimuth SSP position information 513a and/or elevation SSP position information 513b and/or elevation object position information 510b for the usage in the extended elevation range computations.

The extended elevation range computations comprise, for example, a provision of one or more extended azimuth gain values 309a. The extended azimuth gain values 309a may, for example, correspond to the azimuth gain values 302a, but may have a modified association with azimuth angles. In other words, the extended azimuth gain values 309a (or the set of extended azimuth gain values) may, for example, be an angle-shifted version of the azimuth gain values 302a (or, more precisely, of the set of azimuth gain values). However, the extended azimuth gain values 309a may, for example, be derived from the azimuth gain values 302a, or may be obtained using an azimuth difference angle calculation 308 and an azimuth gain function application 309.

Similarly, the elevation range extension processing comprises a provision of extended elevation gain values 311a on the basis of the elevation object position information 510b and the elevation SSP position information 513b. For example, the elevation difference angle calculation 310 may compute angle differences between an elevation object position and elevation spread supporting point positions in an extended elevation range, for example, between +90 degrees and +180 degrees or between −90 degrees and −180 degrees. Accordingly, the elevation gain function application 311 may apply a gain function to the angle differences determined in the elevation difference angle calculation 310, to obtain the extended elevation gain values 311a (or more precisely, a set of extended elevation gain values) which are, for example, associated with elevation SSP positions in the extended elevation range. However, it should be noted that the extended elevation gain values 311a may optionally also be determined on the basis of the elevation gain values 305a, for example, using an appropriate mapping (or re-sorting).

Moreover, one or more extended azimuth gain values 309a may be combined, for example, multiplicatively, with one or more corresponding extended elevation gain values 311, to thereby obtain contributions 312a to obtain values 314a associated with spread support points. For example, the contributions 313a and the contributions 312a, which are associated with identical spread support points, may be summed in the summation 314, to obtain the gain values 314a, which are associated with spread support points. Moreover, a normalization 315 may optionally be applied to the gain values 314, to obtain the spread gain values 514. The spread gain values 514 may, for example, correspond to the spread gains 1332 described above. For example, the normalization 315 may account for a spread width and may help to avoid a change of a signal energy due to the spreading.

Regarding the overall functionality of the spread gain determination 500, it should be noted that azimuth gain values and elevation gain values may be determined independently for a plurality of spread supporting point positions having different azimuth values and for a plurality of spread supporting point positions having different elevation values. Gain values for a larger number of spread support points are then obtained by a combination of azimuth gain values and elevation gain values. The standard azimuth gain values and the extended azimuth gain values may also be used to reflect a spreading over the head of the user or below the user. Azimuth gain values, elevation gain values, extended azimuth gain values and extended elevation gain values associated with the same spread support point are combined, to thereby efficiently obtain a gain value 214 associated with the respective spread support point. Such a combination is performed for different spread support points (or even for all spread support points, or for all spread support points except for those which are located at the poles).

Accordingly, by using the extended elevation range processing (for example, comprising blocks 307, 308, 309, 310 and 311), an overhead spreading, or a spreading below a listener, can be easily implemented by allowing, in the extended elevation range, elevation angles larger than 90 degrees and/or elevation angles smaller than −90 degrees. By providing extended azimuth gain values and extended elevation gain values, pairs of which are associated with spread supporting points, a computational efficiency can be improved, since pairs of an extended azimuth gain value and of an extended elevation gain value can be combined (e.g. multiplied) in order to obtain the spread gain 314a (or a contribution 312a to the spread gain 314a).

To conclude, the spread gain determination 500 is highly efficient and allows for a determination of spread gains, even if an audio object is spread over the head of the listener or below the listener.

Moreover, it should be noted that the spread gain determination 500 may optionally be supplemented using any of the features, functionalities and details disclosed herein, both individually and in combination.

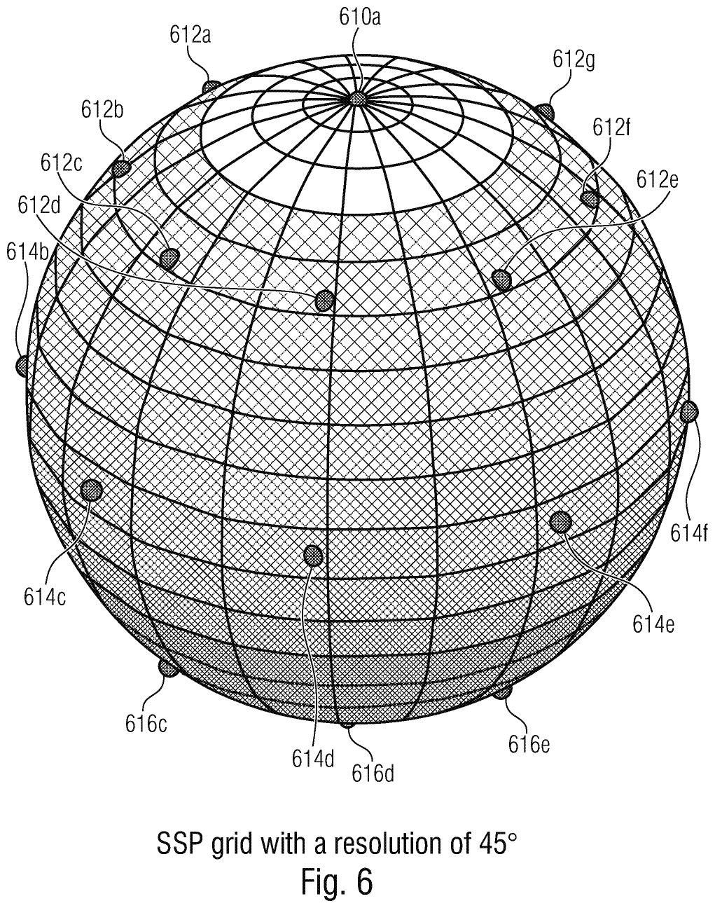

### 1.F Spread Support Point Width According to FIG. 6

FIG. 6 shows a representation of an example spread support point grid with a resolution of 45 degrees. As can be seen in FIG. 6, spread support points 610a, 612a, 612a, 612b, 612c, 612d, 612e, 612f, 612g, 614b, 614c, 614d, 614e, 614f, 616c, 616d, 616e are arranged on a sphere. In particular, the spread support points 612a to 612g, 614b to 614f and 616c to 616e are arranged on circles having constant elevations. The spread supporting point 610a is at a pole of a spherical coordinate system (e.g. at an elevation of +90 degrees). Moreover, it should be noted that spread support points 612b, 614b lie on a semi-circle having a constant azimuth angle. Similarly, spread support point 612c, 614c, 616c lie on a semi-circle having a constant azimuth angle.

Generally speaking, the spread supporting points are arranged on a grid defined by circles of constant elevation and by semi-circles or circles having constant azimuth value. Accordingly, there is typically a plurality of spread supporting points having an identical elevation angle, and there is also typically a plurality of spread supporting points having an identical azimuth angle.

For further (optional) details, reference is also made to the additional explanations regarding the position of spread support points provided herein.

However, it should be noted that the resolution of 45 degrees should be considered as an example only, and that different resolutions may also be chosen. For example, a resolution in an azimuth direction and a resolution in an elevation direction may naturally be different.

### 1.G Polynomial Gain Function

As already described above, the usage of a polynomial gain function is advantageous, since such a polynomial gain function (for example, comprising a degree of two or three) can be evaluated with low computational complexity.

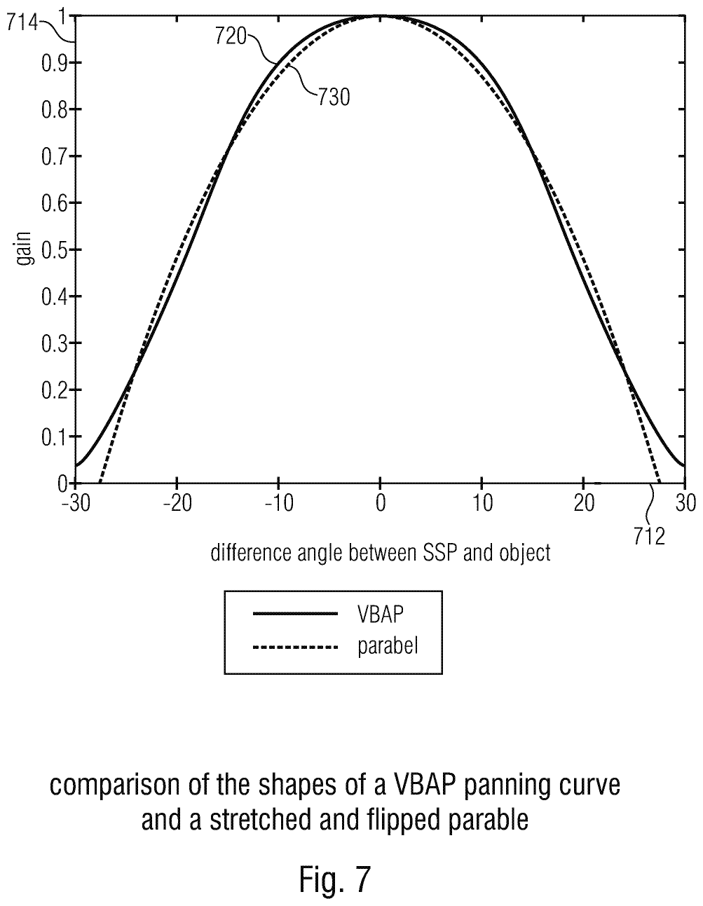

FIG. 7 shows a comparison of the shapes of a VBAP panning curve and a stretched and flipped parable. For example, an abscissa 712 describes a difference angle (for example, an elevation difference angle or an azimuth difference angle) between a currently considered spread supporting point and an object. An ordinate 714 describes a gain or a normalized gain. A first curve 720 describes a gain which would be obtained using a VBAP. A second curve 730 describes a gain which can be obtained by a (stretched and flipped) parable, values of which are limited to be non-negative. As can be seen, the parable-based gain function is a very good approximation of the VBAP gain function.

Accordingly, the parable gain function can be used in any of the apparatuses and methods described herein to map an angle difference onto a gain value. In other words, the parable-based gain function may, for example, be used in the spread gain calculation 201 or in the spread object loudspeaker gain determination 1240 or in the mapping 1334. For example, the parable-based gain function may replace (or approximate) the spread gain functions shown in FIG. 3 and also the gain curve shown in FIG. 4. Furthermore, the parable-based gain function shown in FIG. 7 can also be used in the blocks 302, 309, 311, 305 of the spread gain determination 500.

However, it should be noted that the parable can naturally be adapted in dependence on a spread (for example, in dependence on an azimuth spread or an elevation spread). Furthermore, the parable could naturally be scaled in accordance with the specific needs of the application, wherein the center value of the parable may be changed, and/or wherein the width of the parable may be changed.

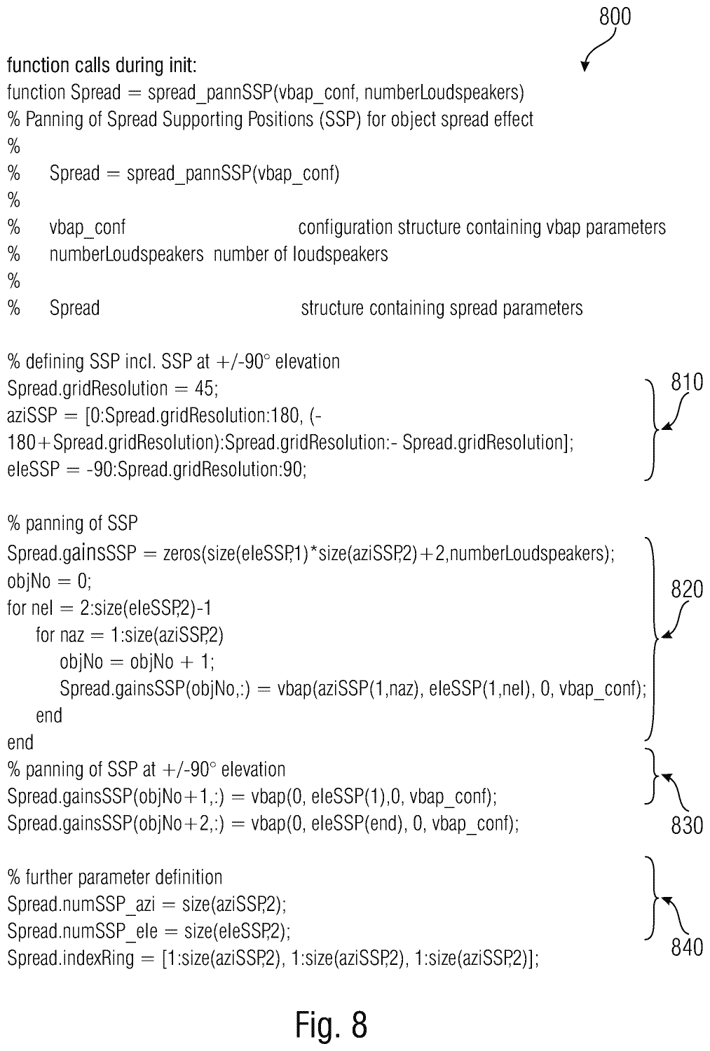

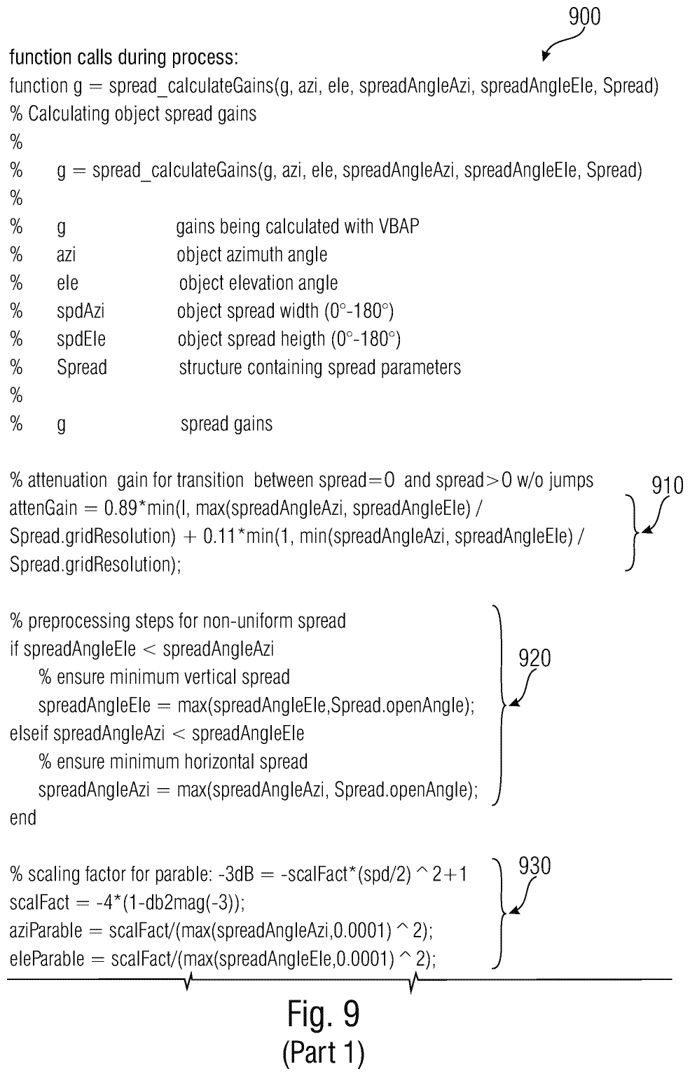

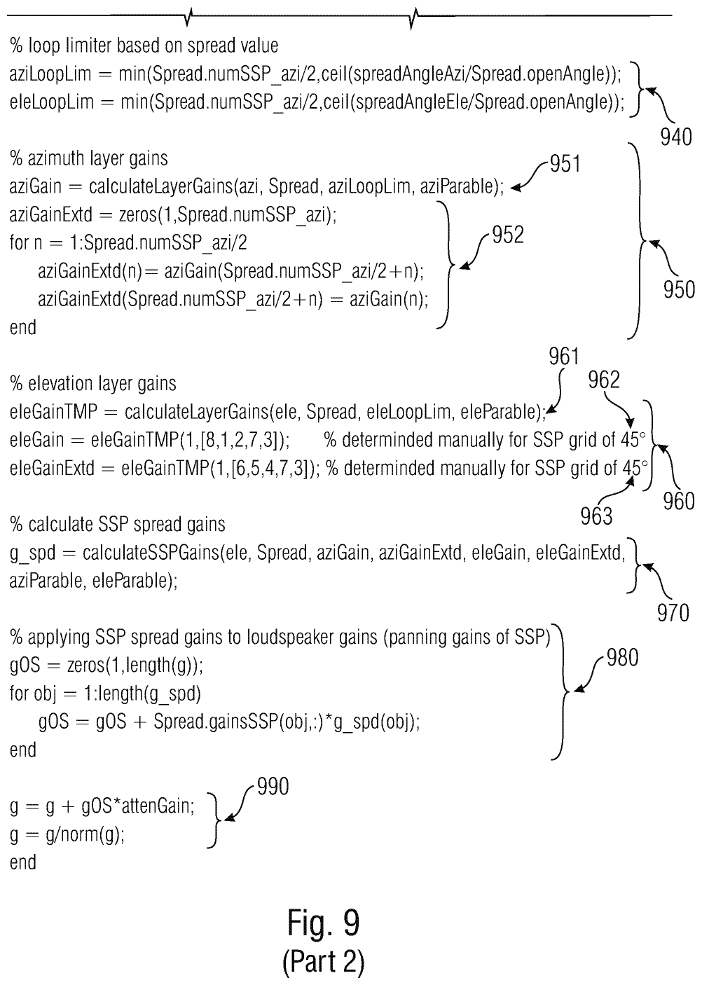

### 1.H Implementation According to FIGS. 8 to 11

FIGS. 8 to 11 illustrate a MATLAB code example of a concept and method for determining loudspeaker gains describing gains for an inclusion of one or more audio object signals into a plurality of loudspeaker signals.

It should be noted that the concept as outlined with reference to FIGS. 8 to 11, or parts or details thereof, can optionally be used in any of the embodiments described herein.

The method comprises an initialization which is performed by an initialization function “spread_pannSSP”. This initialization function uses, as an input information, a configuration structure containing VBAP parameters. The initialization function also receives an information regarding a number of loudspeakers. However, it should be noted that the initialization function does not necessarily need to use these input parameters.

However, the initialization typically comprises a selection (or definition) of spread supporting points. For example, spread supporting points can be defined by a grid of azimuth angles and elevation angles in a spherical coordinate system (wherein, for example, all spread supporting points may have an equal radius). For example, azimuth angles of the spread supporting points may be defined in an array aziSSP, and elevation angles of the spread supporting points may be defined in an array eleSSP. A definition of spread supporting points is shown at reference numeral 810. The definition of spread supporting points shown at reference numeral 810 may, for example, correspond to the grid creation 204.

The initialization also comprises a panning of spread supporting points, which is shown at reference numeral 820. The panning of spread supporting points shown at reference numeral 820 may, for example, correspond to the panning of spread supporting points shown at reference numeral 205 in FIG. 2. For example, for each of the spread supporting points, a panning of an audio signal to be rendered at the position of the respective spread supporting point onto the actual loudspeaker signals will be determined. In other words, for each spread supporting point, scaling values are determined which describe a panning of a signal to be rendered at the position of the respective spread supporting point to the actual loudspeaker signals. These gain values are stored in a data structure named “Spread.gainsSSP”.

A special treatment may be applied for spread supporting points which are arranged at the poles of the spherical coordinate system (e.g. at an elevation of +/−90 degrees). This is shown at reference numeral 830. However, it should be noted that the specific details how these panning gain values (for panning audio objects at the spread supporting point positions onto loudspeaker signals) are not of specific relevance for the present invention. In the given example, a function vbap is used, but other functions (e.g. other panning functions) could be used as well.

Initialization 800 also comprises an initialization of some variables (or constants), which are used in the further processing. This initialization is shown at reference numeral 840.

However, it should be noted that the details of the initialization 800 should be considered as being optional.

In the following, function calls, which are typically executed multiple times for different objects, will be described. A main function is called “spread_calculateGains”. This main function may, for example, receive gains g, which are provided by an object panning (for example, by the object panning 202) or by the panned object loudspeaker gain determination 1230) and provides, on the basis thereof, spread gains (also designated with g), which may correspond to “resulting loudspeaker gains” 214 or loudspeaker gains 1214, 1314. In addition, the main function receives an object azimuth angle information azi, an object elevation angle information ele, an object spread width spdAzi (or spreadAngleAzi), an object spread height spdEle (or spreadAngleEle) and a data structure comprising spread parameters which may, for example, be provided by the initialization described above.

The main function 900 may, for example, comprise a determination of an attenuation gain, which is shown at reference numeral 910. For example, the attenuation gain attenGain may be determined in dependence on the object spread width and the object spread height, and also in dependence on a spread grid resolution. For example, the computation rule shown at reference numeral 910 may be used. However, generally speaking, the attenuation gain may increase with increasing maximum object spread and also with increasing minimal object spread. Accordingly, if the spread of an object is comparatively large, spread object loudspeaker gains will be weighted relatively strong (in relationship to panned object loudspeaker gains), while the spread object loudspeaker gains will be weighted relatively weak if the spread is comparatively small.

In a further preprocessing step 920, an object is spread width and/or an object spread height will be adjusted to ensure that a minimum object spread width and/or a minimum object spread height are used in the further processing. In particular, a smaller one of the object spread width and of the object spread height will be adjusted to take a minimum value if it is smaller than said respective minimum value.

In a further preprocessing step, which is shown at reference numeral 930, parameters of parables, which are used for the determination of gain values, are computed, for example, on the basis of respective spread angles.

Moreover, in a preparation step 940, loop limit values aziLoopLim and eleLoopLim are computed, which determine a number of computation steps executed in a calculation of layer gains. By the (optional) limitation of the computation steps performed in the calculation of the layer gains, a computational complexity can be achieved in some cases.

Moreover, the main function 900 also comprises a determination of azimuth layer gains, which is shown at reference numeral 950. In a first substep 951, an array of azimuth layer gains is determined by calling the function “calculateLayerGains”. The azimuth layer gains computed in step 951 are stored in an array aziGain. In a further substep 952, an angle-shifted version of the azimuth layer gains is obtained and stored in an array aziGainExtd. In other words, entries of the array aziGain are copied, in a modified order, into the array aziGainExtd.

It should be noted that the step 951 may, for example, corresponds to the functionalities 301, 302 as shown in FIG. 3. Moreover, it should be noted that the step 952 may correspond to the functionalities as shown at reference numerals 308 and 309 in FIG. 3. In other words, instead of performing the functionalities 301 and 302 as shown in FIG. 3, the functionality shown in reference numeral 951 could be used, or vice versa. Moreover, instead of performing the functionality as shown at reference numerals 308, 309 in FIG. 3, the functionality shown at reference numeral 952 could be used, or vice versa. For example, the arrays aziGain and aziGainExtd may represent layer gains associated with different azimuth angles, shifted relatively to each other by 180 degrees. For example, a first element of the array aziGain may correspond to an azimuth angle ϕ₁, and a first element of the array aziGainExtd may correspond to an azimuth angle ϕ₁+180 degrees.

The main function 900 may also comprise a determination of elevation layer gains, which is shown at reference numeral 960. For this purpose, the function “calculateLayerGains may be used (again), which returns an intermediate array of values, as shown at reference numeral 961. From this intermediate array of values, eleGainTMP, an array of elevation layer gains, eleGain may be determined by an appropriate selection of entries of the intermediate array of values, as shown at reference numeral 962. Similarly, an extended array of elevation layer gains may also be determined using an appropriate selection and order of entries of the intermediate array, as shown at reference numeral 963.

The functionality as shown at reference numerals 961 and 962 may, for example, correspond to the functionality of blocks 304 and 305, and the functionality as shown at blocks 961 and 963 may, for example, correspond to the functionality as shown in blocks 310 and 311.

In other words, the functionality as shown at reference numerals 961 and 962 may take the place of the functional blocks 304, 305, and the functionality as shown at reference numerals 961, 963 may take the place of the functionality as shown in blocks 310, 311. However, alternatively, the functionality of blocks 304, 305 and the functionality of blocks 310, 311 may be performed instead of the functionality 960.

In a further step, shown at reference numeral 970, the main function 900 calculates spread supporting point spread gains on the basis of the azimuth layer gains and on the basis of the elevation layer gains computed before. For this purpose, a function “calculate SSPGains” is called, which will be described later on.

Accordingly, the spread supporting point spread gains, designated by an array g_spd, are obtained, which describe using which scaling an audio object should be rendered at the spread supporting points. However, since it is desired to know using which scaling an audio object signal should be rendered in the loudspeaker signals, the spread supporting point spread gains are mapped to loudspeaker gains in a step 980, which can be understood as a panning of audio signals to be rendered at the positions of the spread supporting points to actual loudspeaker signals (associated with loudspeakers at the actual loudspeaker positions, which are typically different from the spread supporting points).

For this purpose, results of the previously performed panning of spread supporting points (performed in the initialization 800) is exploited. Products of sets of spread supporting point panning gains and spread supporting point spread gains are summed up, for example, over all spread supporting points. In other words, a spread supporting point panning gain (or a set of spread supporting point panning gains) is associated with each spread supporting point (referenced by running variable obj), and a spread supporting point spread gain is also associated with each spread supporting point.

It should be noted that the step 980 may, for example, correspond to the functionality shown at reference numeral 206. Accordingly, the functionality of the block 206 could be replaced by the functionality shown at reference numeral 980, and vice versa.

In a step 990, the obtained (spread object) loudspeaker gains gOS are combined with the input gain values g which may, for example, be panned object gain values. The scaling of the spread gain values gOS is determined, for example, by the above-mentioned attenuation gain attenGain. Moreover, the step 990 optionally comprises a normalization of the result of said combination of the panned gain values and of the spread gain values.

For example, the step 990 may correspond to the functionality of block 203.

Regarding the overall functionality of the main function 900, it should be noted that the main functionalities lie in steps 950, 960, 970 and 980. In the step 950, an array of “layered gain values” is computed, which describes a spreading of an audio object in an azimuth direction and, more precisely, gain vales associated with azimuth values of spread supporting points. In this step, an object spread in an azimuth direction is considered. Also, the extended azimuth gain values which are cyclically shifted with respect to the azimuth gain values in the array aziGain, help to form an “over-the-head” spreading.

In step 960, spread values are computed which are associated with a given azimuth value and different elevation values associated with spread supporting points. Here, the elevation position of the audio object, and the object spread in an elevation direction are considered. Also, an extended array of elevation layer gains is obtained, to support an overhead spreading of an audio object.

In the step 970, the values of the azimuth layer gains and of the elevation layer gains are combined, to compute gain values associated with all supporting point positions.

Consequently, in the step 980, the gain values associated with supporting point positions are effective mapped to gain values associated with loudspeaker signals.

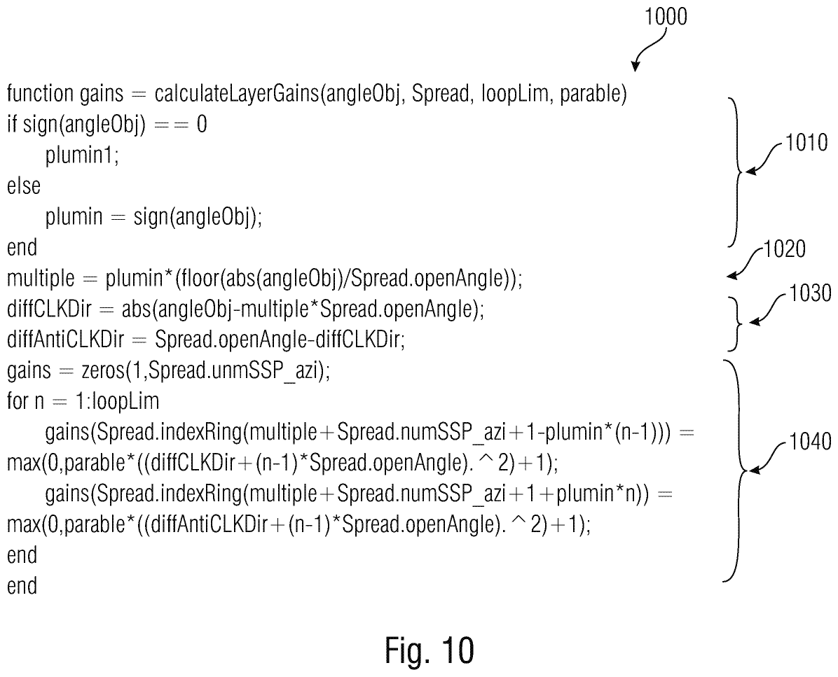

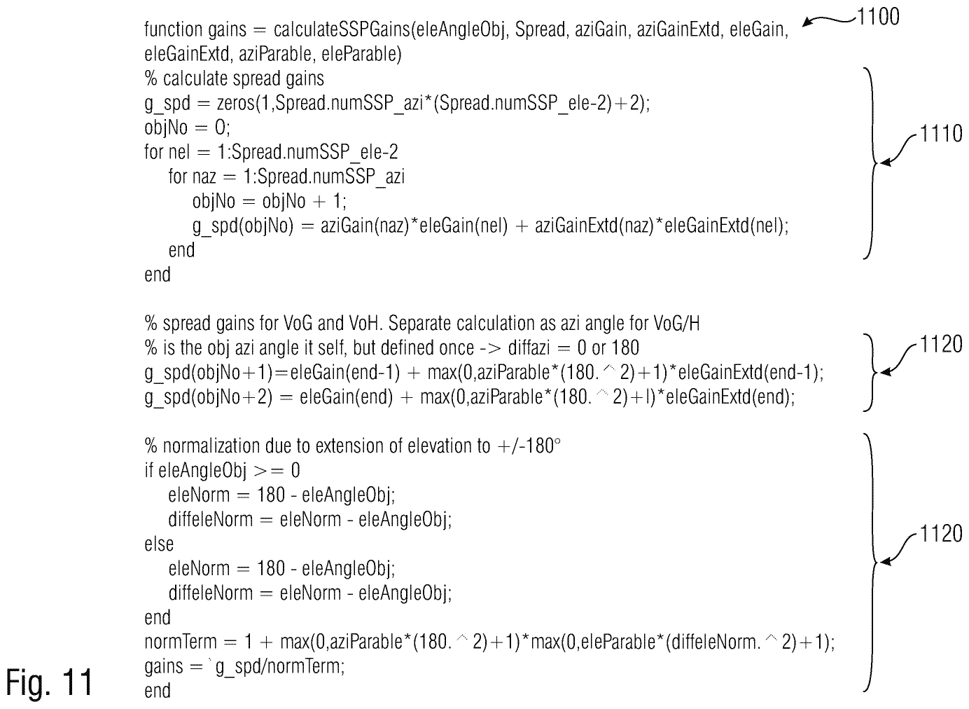

In the following, some details of the functions “calculate layer gains” and “calculate SSPGains” will be described taking reference to FIGS. 10 and 11.

FIG. 10 shows a MATLAB code of the function calculateLayerGains. It should be noted that the return value of said function designated with “gains” is an array, wherein an index of the array elements is associated with an azimuth angle or with an elevation angle. Generally speaking, entries of said arrays comprise an approximately parabolic decay with increasing angle difference between an angle position (azimuth angle position or elevation angle position) of the audio object and an angle (e.g., an SSP azimuth angle position or an SSPelevation angle position) associated with the respective entry of the array.

The function 1000 comprises an optional determination of a sign value plumin, which is shown at reference numeral 1010.

Moreover, the function 1000 comprises a determination of an array index (“multiple”) associated with an object position (e.g., an object elevation angle or an object azimuth angle). This determination is shown in reference numeral 1020.

The function 1000 also comprises a computation of a deviation of the object position from positions (angles) of adjacent spread supporting points, which is shown in reference numeral 1030.

Moreover, the function comprises a computation of gain values, which is shown at reference numeral 1040. These gain values are stored in an array “gains”, wherein array indexes are associated with angles (azimuth angles or elevation angles) of the spread supporting points. The gain values themselves are determined using an evaluation of a parable for a respective angle difference between a position of the audio object under consideration and a position of the respective spread supporting point. The gain values are provided by the evaluation of the parable, limited, such that the values remain non-negative. Accordingly, the array “gains” is filled with gain values, which are based on an evaluation of a parable centered at an angle (azimuth angle or elevation angle) of the position of the audio object under consideration (wherein a restriction to non-negative values applies).

Thus, the function “calculate layer gains”, which is shown in reference numeral 1000, allows for a provision of an array of gain values, and, more precisely, spread gain values associated with a constant azimuth angle or, alternatively, a constant elevation angle.

In the following, details of the function “calculate SSPGains” will be described.

The function shown at reference numeral 1100 comprises a calculation of spread gains, which is shown at reference numeral 1110. In particular, one spread gain value is computed for each spread supporting point SSP, wherein a specific handling for spread supporting points at the poles of the polar coordinate system is shown at reference numeral 1120.

However, for each spread supporting point, designated by an elevation index nel and an azimuth index naz, an azimuth gain value aziGain(naz) is multiplicatively combined with an elevation gain value eleGain(nel). This combination may, for example, correspond to the operation shown at block 313. In addition, an associated extended azimuth gain value aziGainExtd(naz) is also multiplicatively combined with an associated extended elevation gain value eleGainExtd(nel), which may correspond to the operation shown at block 312.

Moreover, the results of the multiplicative combinations are then added, which may correspond to the operation shown at block 314. For example, an azimuth gain value and an extended azimuth gain value designated by the same index naz may correspond to angles which differ by 180 degrees. For example, while an azimuth gain value designated by a given index naz may be associated with an azimuth angle of +45 degree, an extended azimuth gain value associated with the same index naz may be associated with an azimuth angle of −135 degree. Moreover, angles associated with the same index nel in the elevation gain array and in the extended elevation gain array may sum up to 180 degrees or may sum up to −180 degrees. For example, a given index nel may designate an entry of the array eleGains which is associated with +45 degree, and the same index nel will designate an entry of the array eleGainExtd associated with an angle of 135 degree. Thus, the angles associated with the given index nel in the arrays eleGain and eleGainExtd may sum up to +180 degree in this example. When using such a combination, it can be ensured that a proper scaling value is obtained with moderate effort. Also, the fact that elevation values are larger than 90 degrees does not excessively increase the computational complexity of the concept.

The specific handling 1120 of the poles (i.e., of gain values associated with the poles) helps to avoid artifacts at the poles.

The function 1000 also comprises a normalization, which is shown in reference numeral 1130 and which may be considered as being optional. Accordingly, the spread gains are optionally normalized in order to bring them into an appropriate range of values.

To conclude, the function 1100 allows for the derivation of gain values associated with the spread supporting points on the basis of an array of gain values associated with a single elevation angle and on the basis of an array of gain value associated with a single azimuth angle.

It should be noted that the functionalities of the functions 800, 900, 1000 and 1100 may optionally be introduced into any of the other embodiments, both individually and in combination. It should also be noted that any of the functionalities described in other embodiments can optionally be introduced into the functions 800, 900, 1000, 1100, both individually and taken in combination.

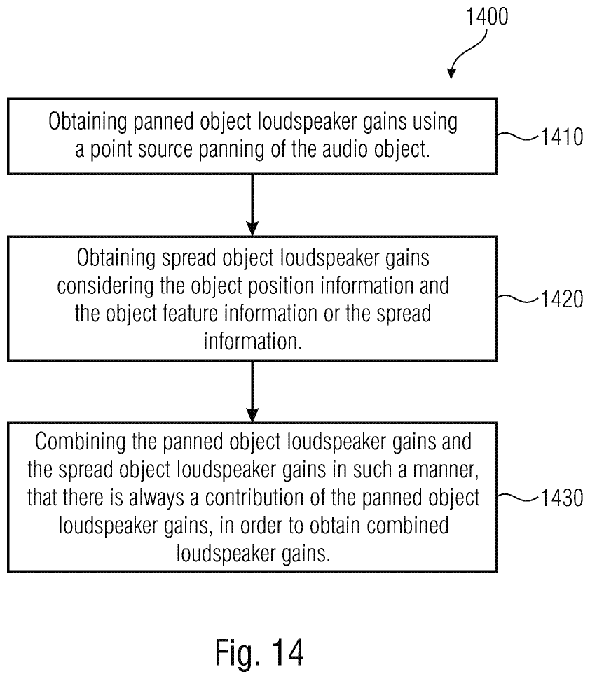

1I. Method according to FIG. 14

FIG. 14 shows a flow chart of a method 1400 for determining loudspeaker gains describing gains for an inclusion of one or more audio object signals into a plurality of loudspeaker signals on the basis of an object position information and an object feature information or spread information.

The method comprises obtaining 1410 panned object loudspeaker gains using a point source panning of the audio object.

the method also comprises obtaining 1420 spread object loudspeaker gains considering the object position information and the object feature information or the spread information.

The method also comprises combining 1430 the panned object loudspeaker gains and the spread object loudspeaker gains in such a manner, that there is a contribution of the panned object loudspeaker gains, in order to obtain combined loudspeaker gains.

The method 1400 is based on the same considerations as the above mentioned apparatus and may optionally be supplemented by any of the features, functionalities and details described herein, both individually and in combination.

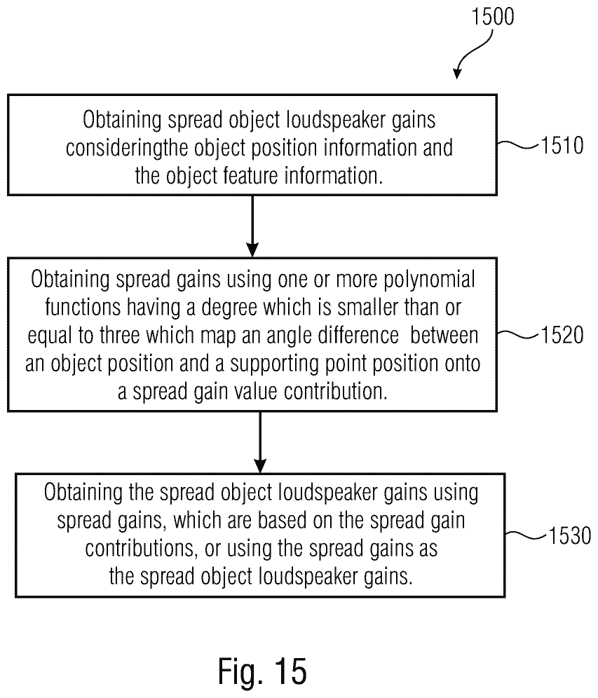

### 1J. Method According to FIG. 15

FIG. 15 shows a flow chart of a method 1500 for determining loudspeaker gains describing gains for an inclusion of one or more audio object signals into a plurality of loudspeaker signals on the basis of an object position information and an object feature information or spread information.

The method comprises obtaining 1510 spread object loudspeaker gains considering the object position information and the object feature information,

The method also comprises obtaining 1520 spread gains using one or more polynomial functions having a degree which is smaller than or equal to three which map an angle difference between an object position and a supporting point position onto a spread gain value contribution.

The method 1530 also comprises obtaining the spread object loudspeaker gains using spread gains, which are based on the spread gain contributions, or using the spread gains as the spread object loudspeaker gains.

The method 1500 is based on the same considerations as the above mentioned apparatus and may optionally be supplemented by any of the features, functionalities and details described herein, both individually and in combination.

### 2. Discussion of Further Embodiments

In the following, an object spread rendering algorithm according to an embodiment of the present invention will be described.

It should be noted that this object spread rendering algorithm may be used independently, but may optionally be supplemented by any of the features, functionalities and details disclosed herein, both individually and in combination.

Also, any of the features, functionalities and details of the concept described in this section may optionally be introduced into any of the apparatuses and method described herein, both individually and taken in combination.

According to an aspect, the basic idea for realizing the spread effect is to activate additional loudspeakers that play back the same object signal with monotonically decreasing intensity, starting from the object position. I.e. for each loudspeaker spreading gains have to be calculated with which the object is played back in order to create a spread effect. The spreading gains can be determined in the following way.

### 2.1 Object Spread Calculation Using Additional Spread Supporting Points

In case of an asymmetrical and/or a 2D loudspeaker setup, in some cases, the loudspeaker positions cannot be used as SSP. The reason is a potential decrease in localization accuracy, as the spread reproduction relies on homogeneously distributed (e.g. on the sphere) SSP. Thus, a grid of equidistantly distributed objects is created (for example, in block 204 of the concept of FIG. 2), where they take on a role of SSP. Each of those SSP is panned (e.g. with VBAP), e.g. in block 205 (panning of spread supporting points). Block 201 (spread gain calculation) uses the SSP positions in order to calculate (for more details, see, for example, section 2.2) the spread gains such that in block 206 (combination) these can be combined (The simplest way to combine both types of gains is a multiplication. Of course, other procedures are possible) with the SSP Panning Gains. In order to reproduce small (e.g. smaller angles than the SSP grid resolution) spread angles the actual object is panned (e.g. with VBAP) (e.g. in block 202, “Panning object”) and combined (e.g. in block 203, “combination”) with the Spread Loudspeaker Gains (more details in Chapter 2.5).

### 2.2 Spread Gain Calculation (e.g in Block 201)

For the calculation of spread gains, for example, a monotonically decreasing function is used. Based, for example, on the spherical distance between the SSP and the object an attenuation gain is determined from that function. For example, the function has a gain value of 1 at the object's position and zero where non spreading effect is desired. For example, the attenuation gain may be limited to the range between 0 and 1, as no amplification is allowed.

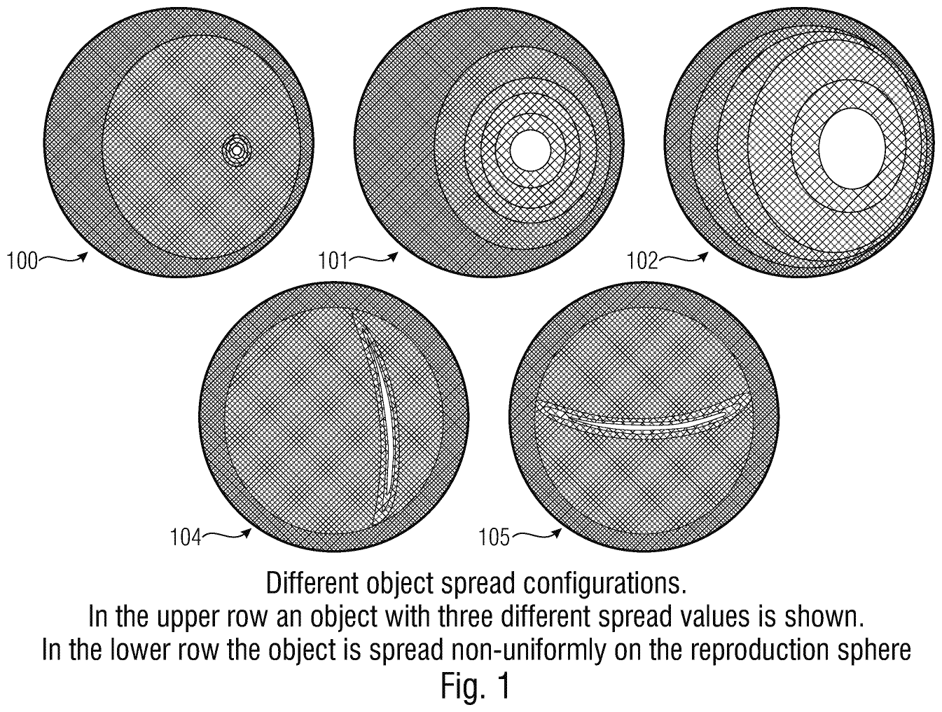

Without further processing steps this procedure only allows the creation of uniform spread patterns, for example as shown in FIG. 1 at reference numerals 100, 101 and 102. In order to achieve non-uniform spread patterns (for example, as shown in FIG. 1 at reference numerals 104 and 105) the spread angles (e.g. [azimuth and elevation] or [width and height]) should, for example, be treated individually. Thus, in the following the weighting function is not designed only one-dimensional (e.g. one spread value) but two-dimensional (e.g. width and height).

For example, as depicted in FIG. 3, the two-dimensional gain function can be modelled as a combination of two one-dimensional gain functions. For instance, in order to model a non-uniform horizontal spread pattern (e.g. FIG. 3. upper plot) a large spread angle is chosen which creates a wide one-dimensional gain function (illustrated as a projection on the left wall). In parallel, for example, a narrow elevation spread angle is chosen that creates a narrow one-dimensional gain function (illustrated as a projection on the right wall). For illustrative purposes the one-dimensional functions are normalized to have a maximum value of 1. For example, the combination of both one-dimensional functions leads to the two-dimensional function. For example, the simplest way of combining the two one-dimensional functions is a multiplication. Of course, different other procedures are possible.

### 2.2.1 The Algorithm

In the following, an example of the spread gain calculation is explained based on one SSP and one object. However, the algorithm can be executed for all SSP subsequently and the resulting spread gains can be accumulated.

For example, in block 301 the absolute difference between the azimuth angle of the SSP and the object is calculated. In block 303 the spread value is, for example, limited such that it does not take values smaller than the SSP grid resolution angle in case of non-uniform spread. Otherwise, the “panning” of the non-uniform spread for a moving object might, in some cases, cause perceivable jumps. Based, for example, on the difference angle from block 301 and the spread angle from block 303 one spread gain component is calculated, while the spread angle controls, for example, the shape/width of the one-dimensional gain curve and the difference angle chooses the value. An example is shown in FIG. 4.

The same procedure is, for example, repeated with the elevation values in the blocks 304, 306 and 305. Both results are multiplied, for example, in block 313. This product represents already one value on the surface of the two-dimensional gain function, but only within the elevation angle range, as the elevation angle is naturally limited to [−90°, 90°]. It should be noted that the definition of a sphere in spherical coordinates typically (or conventionally) only allows the following two combinations. It's either the azimuth angle having a range [−180°, 180°] and the elevation angle [−90°, 90° ] or one can limit the azimuth angle to [−90°, 90] and extend the elevation angle range to [−180°, 180]. Otherwise the rear part of the sphere is defined twice. However, this limitation may be overcome in some embodiments of the present invention.

Assuming, for example, an object at an azimuth angle of 30° and an elevation angle of 80° in the frontal hemisphere having a vertical spread of 60°. As the spread is, for example, symmetrical to the object, for example, 20° of the spread are located in the rear hemisphere, where the azimuth angle is, for example, 210° (or −150°). In that case the horizontal one-dimensional gain function would, for example, mask the spread gains to nearly zero, as the horizontal gain function is chosen to have a narrow shape, such that a vertical spread can be realized.

For this reason, the elevation angle range is, in some embodiments, extended (more optional details are discussed, for example, in section 2.3) to [−180°, 180°] and mapped back to the original range (for example, covered by signal processing blocks 314 and 315). For example, similar to the procedure in blocks 301, 302, 304, 305 and 313 the spread gain component is, for example, calculated in blocks 308, 309, 310, 311 and 312 for the extended elevation range. Finally, for example, the results from blocks 312 and 313 are added in block 314 and normalized (more optional details are discussed, for example, in section 2.4) in block 315.

### 2.3 Elevation Range Extension (e.g in Block 307)

For example, in some embodiments, for rendering spread on the rear hemisphere while the object is on the frontal hemisphere (and vice versa), all SSP have to be mirrored to the extended elevation range (i.e. from [0°, 90°] to [91°, 180° ] and from [−90°, −1°] to [−180°, −91°]. The procedure is explained based on the following example.

Assuming, as an example, an SSP at (20°, 40°) (azimuth and elevation angle) its mirrored SSP is located at (−160°, 140°). This simply means, for example, that the azimuth angle is shifted by 180° and the elevation angle is mirrored to the extended elevation range, while keeping its angular distance to the horizontal plane.

Another example for the lower hemisphere: An SSP at (120°, −70°) is mirrored to (−60°, −110°).

### 2.4 Normalization (e.g in Block 315)

In some cases, extending the elevation angle range, calculating gains in the extended range and adding the additional gain components to the gains determined from the original range might result in amplification. The maximum gain in the original range is, for example, 1 at the position of the object. The gain component from the extended range that is added to the maximum gain from the original range is at the mirrored position and depends, for example, on the spread values (e.g. azimuth and elevation in combination).

For example, for monotonically decreasing functions this addition of both gain components will lead to the maximum possible gain for given spread values. Therefore, it is, in came cases, needed (or advantageous) to normalize the spread gains of the object to this maximum value. The normalization gain is, for example,

$${g}_{norm} = \frac{1}{1 + SGCA * SGCE} ,$$

where SGCA is, for example, the spread gain component determined from block 309 for an azimuth angle difference (The azimuth angle difference between the object and its mirrored position is 180) between the object and its mirrored position, and SGCE is, for example, the spread gain component determined from block 311 for the elevation angle difference between the object and its mirrored position.

### 2.5 Combination of Spread and Object Gains (e.g. in Block 203)

For example, one combination method is the summation of the Object Loudspeaker Gains and the Spread Loudspeaker Gains. The resulting vector containing the loudspeaker gains may, for example, need to be normalized to its Euclidean Norm. Depending on the SSP grid resolution it might, for example, be needed to attenuate the Spread Loudspeaker Gains before combination. For example, In case of a low SSP grid resolution (for example, a low SSP grid resolution allows for low computational complexity) a quickly changing spread value from 0° upwards might cause perceivable artifacts. For example, the attenuation can be determined from the following equation (wherein it should be noted that other equations are also possible):

$${g}_{atten .} = 0.89 * min ( 1. , \frac{max ( {spread}_{azi} , {spread}_{ete} )}{{g}_{res}} ) + 0.11 * min ( 1. , \frac{min ( {spread}_{azi} , {spread}_{ete} )}{{g}_{res}} ) ,$$

where ᵣₑₛ or gᵣₑₛ is the SSP grid resolution, spread_{azi} is the azimuth spread angle and spreadₑₗₑ the elevation spread angle.

### 3. Efficient Implementation

In the following, optional details of an efficient implementation will be described, which may optionally be used in combination with any of the embodiments disclosed herein, both individually and in combination.

As the SSPs are, for example, chosen to be equidistantly distributed over the sphere, they will, for example, have the same angular distances on each of the horizontal/vertical layers.

FIG. 6 depicts an example of a SSP grid with a resolution of 45°. This results in 8 vertical and 5 horizontal layers, where the SSPs at +/−90° elevation should be defined only once.

However, it is sufficient to calculate the difference azimuth angle (e.g in blocks 301 and 308) between the object and the SSPs only once on the horizontal layer and the difference elevation angle (e.g. in blocks 304 and 310) once on the vertical layer.

Furthermore, it is, for example, possible to calculate one difference angle (e.g. on horizontal layer) in clockwise direction and one in counter clockwise direction and to calculate the difference angle from an object to each SSP by counting the SSP indices.

### Example

On the horizontal layer the SPP (or SSP) azimuth angles are: [0°, 45°, 90°, 135°, 180°, −135°, −90°, −45°]. Their already prepared (e.g. already prepared during initialization.) indices could, for example, be [1, 2, 3, 4, 5, 6, 7, 8] that are stored in an index ring (Using an index ring allows, for example, to jump from index 1 to 8 and from 8 to 1. It is, for example, an infinite loop or at least approximates an infinite loop.)

Let's assume, for example, an object azimuth angle of 30°. Regarding the SSP indices, it is located between index 1 and 2. The difference in clockwise direction is 15° and in counterclockwise direction 30°. For a given spread angle of 180° (i.e. +/−90° symmetrically to the object's position) the SSPs at azimuth angels [45°, 90° ] (clockwise) and [0°, −45°] (counter clockwise) are activated. Thus, only two indices in clockwise and two in counterclockwise direction have to be considered during the calculation of the difference angle.

This method has, for example, two advantages. Firstly, by using index rings wrapping of angles outside the interval [−180°, 180° ] are avoided. Furthermore, it allows limiting the calculation to the relevant SSPs. For small spread angles it results in a strong reduction of computational effort.

Another possibility to make the algorithm computationally more efficient is to choose the design of the weighting function accordingly. On the one side, a “Gaussian Bell” like gain curve as introduced before makes use of exponential functions which is realized as power series expansion and therefore computationally inefficient. On the other side, the gain function should ideally have the shape of the resulting function determined from the panning algorithm (e.g. VBAP), as shown in FIG. 7. This is especially desirable (or even needed in some cases) when using non-uniform spread patterns in combination with small spread angles, in order to guarantee smooth object movements.

It has been found that an appropriate compromise is given when an accordingly stretched and flipped parable is used. It avoids exponential/trigonometric functions and approximates the shape of the VBAP panning curve well.

### 4. Implementation Alternatives

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

As an additional remark, it should be noted that the term “considering” may, for example, but not necessarily, have the meaning of “based on” or “in dependence on”.

As an additional remark, it should be noted that the term “describing” may, for example, but not necessarily, have the meaning “representing” or “representing directly or indirectly” or “being a measure of” or “constituting”. For example, a first quantity “describing” another quantity may be equal to the another quantity, or may be proportional to the another quantity, or may be related to the another quantity using a predetermined (linear or non-linear) relationship.

As an additional remark, it should be noted that the wording “associated with an azimuth value” may, for example, have the meaning “having an azimuth value”.

As an additional remark, it should be noted that the wording “associated with an elevation value” may, for example, have the meaning “having an elevation value”.

1. An audio object renderer for determining loudspeaker gains for an inclusion of one or more audio object signals into a plurality of loudspeaker signals on the basis of an object position information and an object feature information,
wherein the audio object renderer is configured to acquire panned object loudspeaker gains using a point source panning of the audio object, wherein the audio object is considered as a point source in the point source panning, and wherein the object feature information is neglected in the point source panning;
wherein the point source panning uses the object position information;
wherein the audio object renderer is configured to acquire object feature information loudspeaker gains, wherein the audio object is spread over an extended region, considering the object feature information;
wherein the audio object renderer is configured to combine the panned object loudspeaker gains and the object feature information loudspeaker gains in such a manner, that there is a contribution of the panned object loudspeaker gains, in order to acquire combined loudspeaker gains;
wherein the determination of the object feature information loudspeaker gains considers an extension of the audio object.

2. An audio object renderer according to claim 1;
wherein the audio object renderer is configured to acquire object feature information loudspeaker gains additionally considering the object position information;

3. An audio object renderer according to claim 1;
wherein said object feature information is audio object spread information;

4. An audio object renderer according to claim 2;
wherein said object feature information is audio object spread information;

5. An audio object renderer for determining loudspeaker gains for an inclusion of one or more audio object signals into a plurality of loudspeaker signals on the basis of an object position information and an object feature information,
wherein the audio object renderer is configured to acquire panned object loudspeaker gains using a point source panning of the audio object, wherein the audio object is considered as a point source in the point source panning, and wherein the object feature information is neglected in the point source panning;
wherein the point source panning uses the object position information;
wherein the audio object renderer is configured to acquire spread object loudspeaker gains, wherein the audio object is spread over an extended region, considering the object position information and the object feature information;
wherein the audio object renderer is configured to combine the panned object loudspeaker gains and the spread object loudspeaker gains in such a manner, that there is a contribution of the panned object loudspeaker gains, in order to acquire combined loudspeaker gains;
wherein the determination of the spread object loudspeaker gains considers an extension of the audio object.

6. An audio object renderer for determining loudspeaker gains for an inclusion of one or more audio object signals into a plurality of loudspeaker signals on the basis of an object position information and a spread information,
wherein the audio object renderer is configured to acquire panned object loudspeaker gains using a point source panning of the audio object, wherein the audio object is considered as a point source in the point source panning, and wherein the spread information is neglected in the point source panning;
wherein the point source panning uses the object position information;
wherein the audio object renderer is configured to acquire spread object loudspeaker gains, wherein the audio object is spread over an extended region, considering the object position information and the spread information;
wherein the audio object renderer is configured to combine the panned object loudspeaker gains and the spread object loudspeaker gains in such a manner, that there is a contribution of the panned object loudspeaker gains, in order to acquire combined loudspeaker gains;
wherein the determination of the spread object loudspeaker gains considers an extension of the audio object.

7. The audio object renderer according to claim 1,
wherein the audio object renderer is configured to evaluate one or more gain functions, which map differences between positions of supporting points and an object position onto one or more spread gain value contributions, and to determine the spread object loudspeaker gains on the basis of the one or more spread gain value contributions.

8. The audio object renderer according to claim 1,
wherein the audio object renderer is configured to determine a weighting of the spread object loudspeaker gains in the combination with the panned object loudspeaker gains, which is a weighted combination, in dependence on a spread in a first direction and in dependence on a spread in a second direction.

9. The audio object renderer according to claim 1,
wherein the audio object renderer is configured to determine a weighting (attenGain, gₐₜₜₑₙ) of the spread object loudspeaker gains in the combination with the panned object loudspeaker gains, which is a weighted combination, in dependence on a product of a spread angle in a first direction and of a spread angle in a second direction.

10. The audio object renderer according to claim 1,
wherein the audio object renderer is configured to add panned object loudspeaker gains, weighted with a fixed weight, and spread object loudspeaker gains, weighted with a variable weight which is dependent on a spread angle in a first direction and a spread angle in a second direction.

11. The audio object renderer according to claim 10,
wherein the audio object renderer is configured to normalize a result of the addition of the panned object loudspeaker gains, weighted with a fixed weight, and of the spread object loudspeaker gains, weighted with a variable weight.

12. The audio object renderer according to claim 1,
wherein the audio object renderer is configured to determine a weighting attenGain of the spread object loudspeaker gains in the combination with the panned object loudspeaker gains, which is a weighted combination, according to
attenGain=0.89f*min(c₁,max(spread_{azi},spreadₑₗₑ)/gᵣₑₛ₁)+0.11f*min(c₂,min(spread_{azi},spreadₑₗₑ)/gᵣₑₛ₂);
wherein c₁ is a predetermined value;
wherein c₂ is a predetermined value;
wherein gᵣₑₛ₁ is a predetermined value;
wherein gᵣₑₛ₂ is a predetermined value;
wherein spread_{azi} is a spreading angle of an audio object in an azimuth direction; and
wherein spreadₑₗₑ is a spreading angle of the audio object in an elevation direction; and
wherein min(.) is a minimum operator; and
wherein max(.) is a maximum operator.

13. The audio object renderer according to claim 1,
wherein the audio object renderer is configured to increase a relative contribution of the spread object loudspeaker gains when compared to the panned object loudspeaker gains with increasing spread angles of the audio object.

14. The audio object renderer according to claim 1,
wherein the audio object renderer is configured to acquire spread object loudspeaker gains considering the object position information and the spread information and using a representation of supporting point positions in polar coordinates; and
wherein the audio object renderer is configured to provide the loudspeaker gains on the basis of the spread object loudspeaker gains.

15. The audio object renderer according to claim 1,
wherein the audio object renderer is configured
to evaluate one or more angle differences between an azimuth position of the audio object and of one or more supporting points, and/or
to evaluate one or more angle differences between an elevation position of audio object and elevation positions of one or more supporting points,
in order to acquire the spread loudspeaker gains.

16. The audio object renderer according to claim 1,
wherein supporting point positions are arranged on a sphere within a tolerance of +/−10% or +/−20% of a radius of the sphere.

17. The audio object renderer according to claim 1,
wherein supporting point positions comprise a uniform azimuth angle spacing along a circle comprising a constant elevation and a constant radius, and/or
wherein supporting point positions comprise a uniform elevation angle along a circle comprising a constant azimuth and a constant radius.

18. Audio object renderer according to claim 1,
wherein the object renderer is configured to acquire the spread object loudspeaker gains such that an audio object is spread over a region which extends in a first hemisphere, in which the audio object is located, and which also extends in a second hemisphere, an azimuthal position of which is opposite to the first hemisphere.

19. Audio object renderer according to claim 18,
Wherein the audio object renderer is configured to use an extended elevation range between −180 degree and +180 degree.

20. Audio object renderer according to claim 18,
wherein the audio object renderer is configured to compute, for a given object position and for a given spread
a first set of azimuth gain values describing contributions to the spread gains for a plurality of azimuth values associated with supporting point positions or supporting point azimuth indices, which is associated with elevation values in an original elevation value range which indicates no crossing of a pole of the spherical coordinate system, and
a second set of azimuth gain values describing contributions to the spread gains for a plurality of azimuth values associated with supporting point positions or supporting point azimuth indices, which is associated with elevation values in an extended elevation value range which indicates a crossing of one of the poles of the spherical coordinate system, and
and to derive the spread gains using the first set of azimuth gain values and using the second set of azimuth gain values.

21. Audio object renderer according to claim 20,
wherein the audio object renderer is configured to compute, for a given object position and for a given spread
a first set of elevation gain values describing contributions to the spread gains for a plurality of elevation values associated with supporting point positions or loudspeaker azimuth indices or supporting point elevation indices, which is associated with elevation values in an original elevation value range which indicates no crossing of a pole of the spherical coordinate system, and
a second set of elevation gain values describing contributions to the spread gains for a plurality of elevation values associated with supporting point positions or loudspeaker elevation indices or supporting point elevation indices, which is associated with elevation values in an extended elevation value range which indicates a crossing of one of the poles of the spherical coordinate system, and
to derive the spread gains using the first set of azimuth gain values, using the second set of azimuth gain values, using a first set of elevation gain values, and using the second set of elevation gain values.

22. Audio object renderer according to claim 18,
wherein the audio object renderer is configured to combine values of the first set of azimuth gain values and of the first set of elevation gain values and to combine values of the second set of azimuth gain values and of the second set of elevation gain values.

23. Audio object renderer according to claim 18,
Wherein the second set of azimuth gain values represents an evolution of gain values over an azimuth angle which is shifted by 180 degrees when compared to an evolution of gain values over the azimuth angle represented by the first set of azimuth gain values.

24. Audio object renderer according to claim 18,
wherein the first set of azimuth gain values represents an evolution of gain values over a range of 360 degrees in view of an azimuth object position and an azimuth spread angle with an angle accuracy determined by a number of loudspeakers or by a number of supporting points, and/or
wherein the second set of azimuth gain values represents an evolution of gain values over a range of 360 degrees in view of an azimuth object position, rotated by 180 degrees, and an azimuth spread angle with an angle accuracy determined by a number of loudspeakers or by a number of supporting points.

25. Audio object renderer according to claim 18,
wherein the first set of elevation gain values represents an evolution of gain values over an elevation range between −90 degree and +90 degree in view of an elevation object position, and an elevation spread angle, and/or
wherein the second set of elevation gain values represents an evolution of gain values over an elevation range between −180 degree to −90 degree and between +90 degree and +180 degree in view of an elevation object position, and an elevation spread angle.

26. Audio object renderer according to claim 1,
Wherein the audio object renderer is configured to determine loudspeaker gains describing gains for an inclusion of one or more audio object signals into a plurality of loudspeaker signals on the basis of an object position information and a spread information,
wherein the object renderer is configured to acquire spread object loudspeaker gains considering the object position information and the spread information,
wherein the object renderer is configured to acquire spread gains using one or more polynomial functions comprising a degree which is smaller than or equal to three which map an angle difference between an object position and a supporting point position onto a spread gain value contribution, and
wherein the object renderer is configured to acquire the spread object loudspeaker gains using spread gains, which are based on the spread gain contributions.

27. Audio object renderer according to claim 26,
wherein a width of the one or more polynomial functions is determined by the spread information.

28. Audio object renderer according to claim 26,
wherein the object renderer is configured to acquire a spread gain value using a first polynomial function, which maps an azimuth angle difference between an object position and a supporting point position onto a first spread gain value contribution, and using a second polynomial function, which maps an elevation angle difference between an object position and a supporting point position onto a second spread gain value contribution.

29. The audio object renderer according to claim 28,
wherein the audio object render is configured to combine the first spread gain contribution and the second spread gain contribution, to acquire a spread gain value.

30. Audio object renderer according to claim 26,
wherein the object renderer is configured to compute, for a given object position and for a given spread
a set of azimuth gain values describing contributions to the spread gains for a plurality of azimuth values associated with supporting point positions or loudspeaker azimuth indices or supporting point azimuth indices, and/or
a set of elevation gain values describing contributions to the spread gains for a plurality of elevation values associated with supporting point positions or loudspeaker elevation indices or supporting point elevation indices,
and to derive the spread gains using the set of azimuth gain values.

31. Audio object renderer according to claim 30,
wherein the audio object renderer is configured to combine an element of the set of azimuth gain values associated with a currently considered loudspeaker or a currently considered supporting point with an element of the set of elevation gain values associated with the currently considered loudspeaker or the currently considered supporting point, in order to acquire spread gain values, associated with a plurality of different loudspeakers or with a plurality of different supporting points.

32. Audio object renderer according to claim 26,
wherein the audio object renderer is configured to compute, for a given object position and for a given spread
a first set of azimuth gain values describing contributions to the spread gains for a plurality of azimuth values associated with supporting point positions or loudspeaker azimuth indices or supporting point azimuth indices, which is associated with elevation values in an original elevation value range which indicates no crossing of a pole of the spherical coordinate system, and
a second set of azimuth gain values describing contributions to the spread gains for a plurality of azimuth values associated with supporting point positions or loudspeaker azimuth indices or supporting point azimuth indices, which is associated with elevation values in an extended elevation value range which indicates a crossing of a pole of the spherical coordinate system, and
and to derive the spread gains using the set of azimuth gain values and/or using a set of elevation gain values.

33. Audio object renderer according to claim 32,
wherein the audio object renderer is configured to compute, for a given object position and for a given spread
a first set of elevation gain values describing contributions to the spread gains for a plurality of elevation values associated with supporting point positions or loudspeaker azimuth indices or supporting point elevation indices, which is associated with elevation values in an original elevation value range which indicates no crossing of a pole of the spherical coordinate system], and
a second set of elevation gain values describing contributions to the spread gains for a plurality of elevation values associated with supporting point positions or loudspeaker elevation indices or supporting point elevation indices, which is associated with elevation values in an extended elevation value range which indicates a crossing of a pole of the spherical coordinate system, and
to derive the spread gains using the set of azimuth gain values and using a set of elevation gain values.

34. Audio object renderer according to claim 26,
wherein the audio object renderer is configured to pre-compute supporting point panning gains for panning audio signals associated to a plurality of supporting points onto a plurality of loudspeakers during an initialization using a panning, and
wherein the audio object renderer is configured to acquire object-to-supporting-point spread gains describing contributions of an audio object signal to a plurality of supporting point signals using the polynomial function comprising a degree which is smaller than or equal to three; and
wherein the audio object renderer is configured to combine the object-to-supporting-point spread gains and the supporting point panning gains, in order to acquire the spread object loudspeaker gains.

35. Audio object renderer according to claim 26,
wherein the one or more polynomial functions comprising a degree which is smaller than or equal to three are parabolic functions which provide a return value p according to
p=max(0,c1*anglediff²+c2),
wherein c1 is a parameter determining a width of the parabolic function;
wherein c2 is a predetermined value;
wherein angeldiff is an angle difference for which the parabolic function is evaluated; and
wherein max(.,.) is a maximum value operator returning a maximum value of its operands.

36. Audio object renderer according to claim 1,
wherein the audio object renderer is configured to provide the combined loudspeaker gains on the basis of both the point source panning of the audio object signal and a spreading of the audio object signal.

37. Audio object renderer according to claim 1,
Wherein the determination of the object feature information loudspeaker gains spreads the audio object over a larger number of speakers than the determination of the panned object loudspeaker gains.

38. A method for determining loudspeaker gains for an inclusion of one or more audio object signals into a plurality of loudspeaker signals on the basis of an object position information and an object feature information,
wherein the method comprises acquiring panned object loudspeaker gains using a point source panning of the audio object, wherein the audio object is considered as a point source in the point source panning, and wherein the object feature information is neglected in the point source panning;
wherein the point source panning uses the object position information;
wherein the method comprises acquiring object feature information loudspeaker gains, wherein the audio object is spread over an extended region, considering the object feature information
wherein the method comprises combining the panned object loudspeaker gains and the object feature information loudspeaker gains in such a manner, that there is a contribution of the panned object loudspeaker gains, in order to acquire combined loudspeaker gains,
wherein the determination of the object feature information loudspeaker gains considers an extension of the audio object.

39. A method for determining loudspeaker gains for an inclusion of one or more audio object signals into a plurality of loudspeaker signals on the basis of an object position information and an object feature information,
wherein the method comprises acquiring panned object loudspeaker gains using a point source panning of the audio object,
wherein the audio object is considered as a point source in the point source panning, and
wherein the object feature information is neglected in the point source panning;
wherein the point source panning uses the object position information;
wherein the method comprises acquiring spread object loudspeaker gains, wherein the audio object is spread over an extended region, considering the object position information and the object feature information;
wherein the method comprises combining the panned object loudspeaker gains and the spread object loudspeaker gains in such a manner, that there is a contribution of the panned object loudspeaker gains, in order to acquire combined loudspeaker gains
wherein the determination of the spread object loudspeaker gains considers an extension of the audio object.

40. A method for determining loudspeaker gains for an inclusion of one or more audio object signals into a plurality of loudspeaker signals on the basis of an object position information and a spread information,
wherein the method comprises acquiring panned object loudspeaker gains using a point source panning of the audio object, wherein the audio object is considered as a point source in the point source panning, and wherein the spread information is neglected in the point source panning;
wherein the point source panning uses the object position information;
wherein the method comprises acquiring spread object loudspeaker gains, wherein the audio object is spread over an extended region, considering the object position information and the spread information;
wherein the method comprises combining the panned object loudspeaker gains and the spread object loudspeaker gains in such a manner, that there is a contribution of the panned object loudspeaker gains, in order to acquire combined loudspeaker gains;
wherein the determination of the spread object loudspeaker gains considers an extension of the audio object.

41. A method according to claim 38,
wherein the method comprises evaluating one or more gain functions, which map differences between positions of supporting points and an object position onto one or more spread gain value contributions, and determining the spread object loudspeaker gains on the basis of the one or more spread gain value contributions.

42. A method according to claim 38,
wherein the method comprises acquiring spread object loudspeaker gains considering the object position information and the object feature information,
wherein the method comprises acquiring spread gains using one or more polynomial functions comprising a degree which is smaller than or equal to three which map an angle difference between an object position and a supporting point position onto a spread gain value contribution, and
wherein the method comprises acquiring the spread object loudspeaker gains using spread gains, which are based on the spread gain contributions, or using the spread gains as the spread object loudspeaker gains.

43. A method according to claim 38
wherein the method determines loudspeaker gains describing gains for an inclusion of one or more audio object signals into a plurality of loudspeaker signals on the basis of an object position information and a spread information,
wherein the method comprises acquiring spread object loudspeaker gains considering the object position information and the spread information,
wherein the method comprises acquiring spread gains using one or more polynomial functions comprising a degree which is smaller than or equal to three which map an angle difference between an object position and a supporting point position onto a spread gain value contribution, and
wherein the method comprises acquiring the spread object loudspeaker gains using spread gains, which are based on the spread gain contributions, or using the spread gains as the spread object loudspeaker gains.

44. A non-transitory digital storage medium having a computer program stored thereon to perform a method for determining loudspeaker gains for an inclusion of one or more audio object signals into a plurality of loudspeaker signals on the basis of an object position information and an object feature information,
wherein the method comprises acquiring panned object loudspeaker gains using a point source panning of the audio object, wherein the audio object is considered as a point source in the point source panning, and wherein the object feature information is neglected in the point source panning;
wherein the point source panning uses the object position information;
wherein the method comprises acquiring object feature information loudspeaker gains, wherein the audio object is spread over an extended region, considering the object feature information,
wherein the method comprises combining the panned object loudspeaker gains and the object feature information loudspeaker gains in such a manner, that there is a contribution of the panned object loudspeaker gains, in order to acquire combined loudspeaker gains,
wherein the determination of the object feature information loudspeaker gains considers an extension of the audio object,
when said computer program is run by a computer.

45. An audio object renderer for determining loudspeaker gains for an inclusion of one or more audio object signals into a plurality of loudspeaker signals on the basis of an object position information and a spread information,
wherein the audio object renderer is configured to acquire panned object loudspeaker gains using a point source panning of the audio object, wherein the audio object is considered as a point source in the point source panning, wherein the spread information is neglected, and wherein a single loudspeaker is selected for a playback of an audio object or wherein an audio object is distributed to a plurality of loudspeakers which are closest to the audio object,
wherein the panned object loudspeaker gains are based on the object position information;
wherein the audio object renderer is configured to acquire spread object loudspeaker gains based on the object position information and the spread information, wherein the audio object is spread over an extended region;
wherein the audio object renderer is configured to combine the panned object loudspeaker gains and the spread object loudspeaker gains in such a manner, that there is a contribution of the panned object loudspeaker gains, namely that the contribution of the panned object loudspeaker gains in the combination is non-zero, in order to acquire combined loudspeaker gains;
wherein the determination of the spread object loudspeaker gains considers an extension of the audio object;
wherein the audio object renderer is configured to provide the combined loudspeaker gains on the basis of both the point source panning of the audio object signal and a spreading of the audio object signal; and
wherein the determination of the spread object loudspeaker gains spreads the audio object over a larger number of speakers than the determination of the panned object loudspeaker gains.
